(19) United States
(12) Patent Application Publication
(10) Pub. No.: US 2025/0011687 A1
(43) Pub. Date: Jan. 9, 2025

(54) BIODEGRADABLE CHELATING AGENTS AND METHODS FOR FABRIC CARE

(71) Applicant: The Procter & Gamble Company, Cincinnati, OH (US)

(72) Inventors: Linsey Sarah FULLER, Newcastle Upon Tyne (GB); Robert William John STERRY, Newcastle upon Tyne (GB); Philip Frank SOUTER, MORPETH NORTHUMBERLAND (GB)

(21) Appl. No.: 18/741,878

(22) Filed: Jun. 13, 2024

Related U.S. Application Data
(60) Provisional application No. 63/524,257, filed on Jun. 30, 2023.

(51) Int. Cl. C11D 3/20; C11D 1/14; C11D 1/22; C11D 1/29; C11D 1/72; C11D 1/75; C11D 1/83; C11D 17/04

(52) U.S. Cl. CPC C11D 3/2072; C11D 1/83; C11D 17/043; C11D 1/146; C11D 1/22; C11D 1/29; C11D 1/72; C11D 1/75

(57) ABSTRACT

Biodegradable chelating agents may be incorporated into a variety of fabric care compositions and delivery formats. The fabric care compositions may include at least one component, according to Formula 7, as well as combinations and salts thereof:

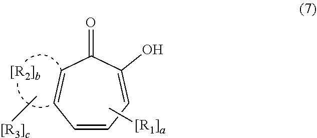

in which:
R₁ is hydroxyl, C₁-C₆ carboxyl, a linear or branched C₁-C₆ alkyl; a linear or branched C₂-C₆ alkenyl; or a linear or branched C₂-C₆ alkynyl group;
a is from 0 to 5;
R₂ is a fused C₁-C₆ cycloalkyl, a fused C₁-C₆ cycloalkoxy, or a fused C₁-C₆ cycloalkenyl;
b is from 0 to 4;
R₃ is oxygen or hydroxyl; and
c is from 0 to 4.

### FIELD

The present disclosure relates generally to chelating agents and methods for using chelating agents and more specifically to biodegradable chelating agents and methods.

### BACKGROUND

The discussion of shortcomings and needs existing in the field prior to the present disclosure is in no way an admission that such shortcomings and needs were recognized by those skilled in the art prior to the present disclosure.

Phosphonate chelants may be employed in various fabric care compositions to improve stain removal. Phosphonate chelants may improve stain removal via heavy metal chelation; in this regard, useful phosphonate chelants tend to have a higher binding efficiency with iron (III) than with calcium. One such phosphonate chelant is 1-Hydroxyethylidene-1,1-diphosphonic acid (HEDP), also known as etidronic acid or etidronate, as shown in Formula 1.

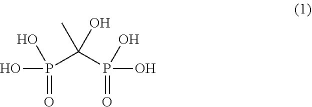

Another phosphonate chelant is diethylene triamine pentamethylene phosphonic acid (DTPMP) as shown in Formula 2.

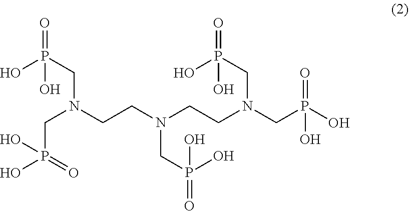 [SMILES: O=P(O)(O)CN(CCN(CP(=O)(O)O)CP(=O)(O)O)CCN(CP(=O)(O)O)CP(=O)(O)O]

Some phosphonate chelants are not readily biodegradable and may survive some wastewater treatments. Such phosphonate chelants may pose adverse effects to aquatic organisms. Therefore, a need exists to replace phosphonate chelants in various fabric care compositions with more biodegradable materials that preferably do not contain phosphorous.

Existing biodegradable replacements for phosphonate chelants include amino acid derivative complexing agents, as well as stereoisomers, and mixtures thereof. For example, methylglycinediacetic acid and salts thereof (MGDA), such as shown in Formula 3, has been used to replace phosphonate chelants.

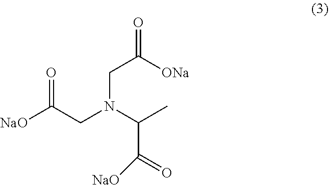

Similarly, L-glutamic acid, N,N-diacetic acid and salts thereof (GLDA) and salts thereof as shown in Formula 4, has been used to replace phosphonate chelants.

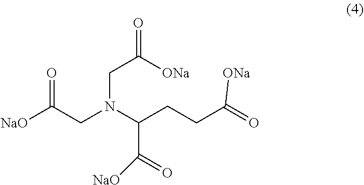

Unfortunately, neither MGDA nor GLDA match HEDP on stain removal performance. Therefore, a need still exists to replace phosphonate chelants in various fabric care compositions with more biodegradable materials that preferably do not contain phosphorous.

### SUMMARY

Various embodiments solve the above-mentioned problems and provide biodegradable chelating agents that may be incorporated into a variety of fabric care compositions and delivery formats and which provide similar or improved results compared to traditional chelating agents.

Various embodiments relate to liquid detergent compositions comprising at least one component, according to Formula 7, as well as combinations and salts thereof:

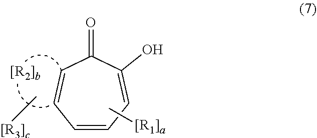

wherein:
R₁ is hydroxyl, C₁-C₆ carboxyl, a linear or branched C₁-C₆ alkyl; a linear or branched C₂-C₆ alkenyl; or a linear or branched C₂-C₆ alkynyl group;
a is from 0 to 5;
R₂ is a fused C₁-C₆ cycloalkyl, a fused C₁-C₆ cycloalkoxy, or a fused C₁-C₆ cycloalkenyl;
b is from 0 to 4;
R₃ is oxygen or hydroxyl; and
c is from 0 to 4.
   Various embodiments relate to single unit dose detergent comprising the liquid detergent compositions. Various embodiments relate to methods for treating a stain on a fabric that comprise washing the fabric in a wash liquor comprising the liquid detergent compositions. Various embodiments relate to the use of a liquid detergent compositions to treat a stain on a fabric.

These and other features, aspects, and advantages of various embodiments will become better understood with reference to the following description, figures, and claims.

### BRIEF DESCRIPTION OF THE DRAWINGS

Many aspects of this disclosure may be better understood with reference to the following figure.

FIG. 1 is a side cross-sectional view of a water-soluble pouch article including a composition contained therein.

It should be understood that the various embodiments are not limited to the examples illustrated in the figures.

### DETAILED DESCRIPTION

### Introduction and Definitions

This disclosure is written to describe the invention to a person having ordinary skill in the art, who will understand that this disclosure is not limited to the specific examples or embodiments described. The examples and embodiments are single instances of the invention which will make a much larger scope apparent to the person having ordinary skill in the art. Unless defined otherwise, all technical and scientific terms used herein have the same meaning as commonly understood by the person having ordinary skill in the art. It is also to be understood that the terminology used herein is for the purpose of describing examples and embodiments only, and is not intended to be limiting, since the scope of the present disclosure will be limited only by the appended claims.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example only of a generic series of equivalent or similar features. The examples and embodiments described herein are for illustrative purposes only and that various modifications or changes in light thereof will be suggested to the person having ordinary skill in the art and are to be included within the spirit and purview of this application. Many variations and modifications may be made to the embodiments of the disclosure without departing substantially from the spirit and principles of the disclosure. All such modifications and variations are intended to be included herein within the scope of this disclosure. For example, unless otherwise indicated, the present disclosure is not limited to particular materials, reagents, reaction materials, manufacturing processes, or the like, as such may vary. It is also to be understood that the terminology used herein is for purposes of describing particular embodiments only and is not intended to be limiting. It is also possible in the present disclosure that steps may be executed in different sequence where this is logically possible.

All numeric values are herein assumed to be modified by the term “about,” whether or not explicitly indicated. The term “about” generally refers to a range of numbers that one of skill in the art would consider equivalent to the recited value (for example, having the same function or result). In many instances, the term “about” may include numbers that are rounded to the nearest significant figure.

In everyday usage, indefinite articles (like “a” or “an”) precede countable nouns and noncountable nouns almost never take indefinite articles. It must be noted, therefore, that, as used in this specification and in the claims that follow, the singular forms “a,” “an,” and “the” include plural referents unless the context clearly dictates otherwise. Thus, for example, reference to “a support” includes a plurality of supports. Particularly when a single countable noun is listed as an element in a claim, this specification will generally use a phrase such as “a single.” For example, “a single support.”

Unless otherwise specified, all percentages indicating the amount of a component in a composition represent a percent by weight of the component based on the total weight of the composition. The term “mol percent” or “mole percent” generally refers to the percentage that the moles of a particular component are of the total moles that are in a mixture. The sum of the mole fractions for each component in a solution is equal to 1.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

In this specification and in the claims that follow, reference will be made to a number of terms that shall be defined to have the following meanings unless a contrary intention is apparent.

“Standard temperature and pressure” generally refers to 25° C. and 1 atmosphere. Standard temperature and pressure may also be referred to as “ambient conditions.” Unless indicated otherwise, parts are by weight, temperature is in ° C., and pressure is at or near atmospheric. The terms “elevated temperatures” or “high-temperatures” generally refer to temperatures of at least 100° C.

“Average size” refers to the particle size. The particle size of a spherical object may be unambiguously and quantitatively defined by its diameter. However, a typical material object is likely to be irregular in shape and non-spherical. There are several ways of extending the above quantitative definition to apply to non-spherical particles. Existing definitions are based on replacing a given particle with an imaginary sphere that has one of the properties identical with the particle. Volume-based particle size equals the diameter of the sphere that has the same volume as a given particle. Area-based particle size equals the diameter of the sphere that has the same surface area as a given particle. Weight-based particle size equals the diameter of the sphere that has the same weight as a given particle. Hydrodynamic or aerodynamic particle size equals the diameter of the sphere that has the same drag coefficient as a given particle.

“Mixing” refers to a unit operation in industrial process engineering that involves manipulation of a heterogeneous physical system with the intent to make it more homogeneous. Mixing is performed to allow heat and/or mass transfer to occur between one or more streams, components, or phases.

“Disposed on” refers to a positional state indicating that one object or material is arranged in a position adjacent to the position of another object or material. The term does not require or exclude the presence of intervening objects, materials, or layers.

“Compositions” include fabric care compositions for handwash, machine wash and/or other purposes and include fabric care additive compositions and compositions suitable for use in the soaking and/or pretreatment of fabrics. They may take the form of, for example, laundry detergents, fabric pre-treatments, fabric conditioners and/or other wash, rinse, dryer added products, and sprays. Compositions in the liquid form may be in an aqueous carrier. In other aspects, the fabric care compositions are in the form of a granular detergent or dryer added fabric softener sheet. The term includes, unless otherwise indicated, granular or powder-form all-purpose or “heavy-duty” washing agents, especially cleaning detergents; liquid, gel or paste-form all-purpose washing agents, especially the so-called heavy-duty liquid (HDL) types; liquid fine-fabric detergents; cleaning auxiliaries such as bleach additives and “stain-stick” or pre-treat types, substrate-laden products, dry and wetted wipes and pads, nonwoven substrates, and sponges; and sprays and mists. Various dosage formats may be used. The composition may be provided in single unit dose (SUD) packets or pouches, including foil or plastic pouches or water soluble pouches, such as a polyvinyl alcohol (PVA) pouch; dosing balls or containers; containers with readily opened closures, such as pull tabs, screw caps, foil or plastic covers, and the like; or other container known in the art. The compositions may be compact compositions, comprising less than about 15%, or less than about 10%, or less than about 7% water.

“Unit dose” or “Single Unit Dose” means an amount of fabric care composition suitable to treat one load of laundry, such as from about 0.05 to about 100 g, or from 10 to about 60 g, or from about 20 to about 40 g.

“Liquid” includes free-flowing liquids, as well as pastes, gels, foams and mousses. Non-limiting examples of liquids include light duty and heavy duty liquid detergent compositions, fabric enhancers, detergent gels commonly used for laundry, bleach and laundry additives. Gases, e.g., suspended bubbles, or solids, e.g. particles, may be included within the liquids.

“Solid” as used herein includes, but is not limited to, powders, agglomerates, and mixtures thereof. Non-limiting examples of solids include: granules, micro-capsules, beads, noodles, and pearlised balls. Solid compositions may provide a technical benefit including, but not limited to, through-the-wash benefits, pre-treatment benefits, and/or aesthetic effects.

It has unexpectedly been discovered that tropolone and derivatives thereof, such as hinokitiol are able to match or to exceed HEDP performance in stain removal for various fabric care applications, like liquid laundry detergents, and single unit dose (SUD) applications. Various embodiments, therefore, meet the need to replace phosphonate chelants in fabric care compositions with biodegradable materials that do not contain phosphorous.

Various embodiments relate to a chelating composition comprising tropolone, a tropolone derivative, as well as salts thereof. Tropolone is also known as 2-Hydroxycyclohepta-2,4,6-trien-1-one and is shown in Formula 5.

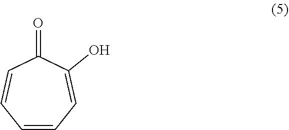

Hinokitiol is a tropolone derivative that is also known as 2-Hydroxy-6-(propan-2-yl)cyclohepta-2,4,6-trien-1-one, as shown in Formula 6.

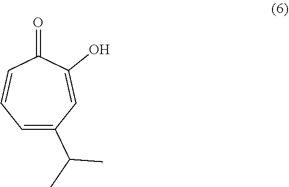

Various embodiments relate to a chelating composition comprising a component according to Formula 7

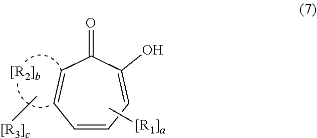

With respect to Formula 7,
R₁ may be hydroxyl, C₁-C₆ carboxyl, a linear or branched C₁-C₆ alkyl; a linear or branched C₂-C₆ alkenyl; or a linear or branched C₂-C₆ alkynyl group;
a may be from 0 to 5;
R₂ may be a fused C₁-C₆ cycloalkyl, a fused C₁-C₆ cycloalkoxy, or a fused C₁-C₆ cycloalkenyl;
b may be from 0 to 4;
R₃ may be oxygen, or hydroxyl; and
c may be from 0 to 4.

It is to be appreciated that the component according to Formula 7 may be tropolone or hinokitiol. Formula 7 may represent tropolone when a, b, and c are 0. Formula 7 may represent hinokitiol when R₁ is a branched C₃ alkyl, a is 1, b is 0, and c is 0. The component according to Formula 7 may also be a variety of other compounds. For example, the component according to Formula 7 may be γ-Thujaplicin as shown in Formula 8.

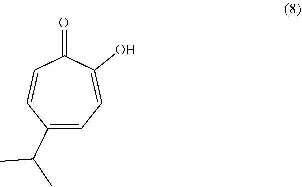

The component according to Formula 7 may be α-Thujaplicin as shown in Formula 9.

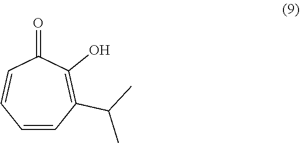

The component according to Formula 7 may be Purpurogallin as shown in Formula 10.

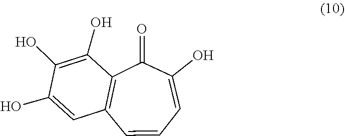 [SMILES: O=c1c(O)cccc2cc(O)c(O)c(O)c12]

The component according to Formula 7 may be Puberulic acid as shown in Formula 11.

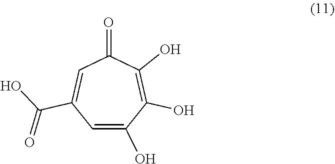 [SMILES: O=C(O)c1cc(O)c(O)c(O)c(=O)c1]

The component according to Formula 7 may be Puberulonic acid as shown in Formula 12.

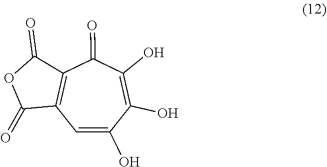 [SMILES: O=C1OC(=O)c2c1cc(O)c(O)c(O)c2=O]

Various embodiments relate to salts of tropolone or tropolone derivatives, and all components according to Formula 7, including but not limited to a sodium salts and/or potassium salts.

Chelation is a type of bonding of ions and molecules to metal ions. It involves the formation or presence of two or more separate coordinate bonds between a ligand and a metal atom. Without being bound by theory, the stain removal effectiveness of a composition comprising one or more chelating agents may depend at least in part on the ability of the chelating agent(s) to bind to iron, which may be present in some stains, such as fruit or beverage stains. Several factors may impact a chelating agent's ability to bind to iron. These factors may include the pKa of the chelating agent compared to the wash pH, and the affinity of the chelating agent to bind with other metals, materials, or compositions in the wash.

Various embodiments may provide or employ a composition that comprises one or more chelating agents having a pKa that is less than the wash pH. For example, according to various embodiments, the chelating agent(s) may have a pKa of about 8, of less than about 8, of about 7, of less than about 7, or in a range of from about 5 to about 7.

Various embodiments may provide or employ a composition that comprises one or more chelating agents exhibiting specific binding efficiencies with specific materials. The binding efficiencies may be expressed as a binding constant. A binding constant (also called formation constant or stability constant) is an equilibrium constant for the formation of a complex in solution. It is a measure of the strength of the interaction between the reagents that come together to form the complex. As an example, various stains may comprise catechins as shown in Formula 13.

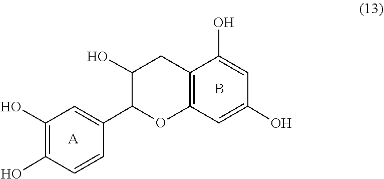

Such catechins may have a binding efficiency of about 3.5 with calcium and of about 19.2 with iron, as shown in Table 1, and are in competition with chelating agents to bind to these materials. The chelating agent(s) according to various embodiments may, therefore, be selected to ensure a lower binding efficiency with calcium and a higher binding efficiency with iron at the wash pH.

Various embodiments may provide or employ a composition that comprises one or more chelating agents having a calcium binding efficiency of about 2.0 to about 7.0, or about 2.2 to about 6.8, or about 2.5 to about 3.5, or about 2.7 to about 3.1, or less than about 6.8. A calcium binding efficiency of less than about 6.8, indicating that the chelating agent is less likely to bind to calcium than HEDP, as shown in Table 1.

Various embodiments may provide or employ a composition that comprises one or more chelating agents having an iron binding efficiency about 10 to about 20, or about 10.5 to about 14.1, or about 11 to about 12.9, greater than about 10, as shown in Table 1.

TABLE 1

| | Catechin | HEDP | Tropolone | Hinokitiol |
|---|---|---|---|---|
| pKa | 8.7 (A), 9.5 (B), | 1.7, 2.5, | 6.7 | about 7 |
| | 11.2(B), 13.4 (A) | 7.3, 10.3 | | |
| Ca²⁺ | 3.5 | 6.8 | 3.1 | 2.2 |
| logK(β₁₁₀) | | | | |
| Fe (III) | 19.2 | 14.1 | 10.5 | 12.9 |
| logK(β₁₁₀) | | | | |

In Table 1, the reaction between metals and ligands is described in terms of logK(β₁₁₀). In this context, K, is the equilibrium constant for the reaction between ligands and metals. The higher K, the more metal is bound. This is illustrated in the following example.

$${LH}_{6} + Fe {⇌}_{K = \frac{{[ LFe ] [ {H}^{+} ]}^{6}}{[ {LH}_{6} ] [ Fe ]}}^{K} LFe + 6 {H}^{+}$$

β, represents the binding efficiency and receives some subscripts (βₘₗₕ) to indicate how many metals (m), ligands (l), and protons (h) respectively are involved. Thus, β₁₁₀ indicates that one metal, one ligand, and no protons are involved.

### Liquid Detergent Composition

Various embodiments relate to a liquid detergent composition comprising at least one component according to Formula 7, combinations and salts thereof. The at least one component may be present in an amount of from greater than about 0 to about 10% by weight, or about 0.5 to about 9.5% by weight, or about 0.5 to about 9.5% by weight, or about 1.0 to about 9.0% by weight, or about 1.5 to about 8.5% by weight, or about 2.0 to about 8.0% by weight, or about 2.5 to about 7.5% by weight, or about 3.0 to about 7.0% by weight, or about 3.5 to about 6.5% by weight, or about 4.0 to about 6.0% by weight, or about 4.5 to about 5.5% by weight, or about 4.0 to about 5.0% by weight of the liquid detergent composition.

It is to be appreciated that the liquid detergent composition may comprise a variety of other components in addition to the at least one component according to Formula 7. For example, the liquid detergent composition may include a surfactant. The liquid detergent composition may be a laundry detergent composition. A liquid “laundry detergent composition” may include any composition intended for the cleaning of fabric in a washing machine or in a hand wash context. The liquid laundry detergent compositions may be used in high efficiency and standard washing machines, in addition to hand washing in a tub or basin for example. It is to be appreciated that the liquid detergent composition may encompass formulations that would be considered to be heavy duty liquid (HDL) detergent compositions or stain pre-treatment compositions, as those terms are used in the art.

The detergent composition may be free of synthetic preservatives. Examples of synthetic preservatives include methylisothiazolinone and benzisothiazolinone.

### Surfactant

The detergent composition may comprise from about 5% to about 75%, or about 5% to about 70%, or about 5% to about 65%, or about 5% to about 55%, or about 5% to about 50%, or about 10% to about 45%, or about 10% to about 40%, by weight of the detergent composition of a surfactant. The surfactant may be anionic, nonionic, amphoteric, zwitterionic, or a combination thereof.

Anionic surfactants may include, for example, alkylbenezene sulfonate, methyl ester sulfonate, alkyl ether carboxylate, alkyl sulfate, alkylalkoxylated sulfate, or a combination thereof. The alkyl benzene sulfonate may comprise a linear alkylbenzene sulphonate. Linear alkylbenzene sulfonate, may have a small amount of branched alkylbenzene sulfonate as a byproduct of the manufacturing process, but this will generally be less than about 5%. The linear alkylbenzene sulphonate may be present, for example, at a level of 0.5% to about 30%, by weight of the liquid detergent composition. The linear alkyl benzene sulphonate may be selected from, for example, alkyl benzene sulfonic acids, alkali metal or amine salts of C₁₀ to C₁₆ alkyl benzene sulfonic acids. In alkyl benzene sulfonic acids or alkali metal or amine salts of C₁₀ to C₁₆ alkyl benzene sulfonic acids, the linear alkyl benzene sulphonate surfactant can comprise greater than 50% C₁₂, greater than 60%, greater than 70% C₁₂, more preferably greater than 75%. The linear alkylbenzene sulphonate may comprise a C₁₀-C₁₆ alkyl benzene sulfonate, a C₁₁-C₁₄ alkyl benzene sulphonate, or a mixture thereof. The alkylbenzene sulphonate may be an amine neutralized alkylbenzene sulphonate, an alkali metal neutralized alkylbenzene sulphonate, or a mixture thereof. The amine comprises, for example, monoethanolamine, triethanolamine, monoisopropanolamine, or a mixture thereof. The alkali or alkali earth metal comprises, for example, sodium, potassium, magnesium, or a mixture thereof.

Another acceptable anionic surfactant comprises an alkyl sulphate anionic surfactant. The alkyl sulphate anionic surfactant may include, for example, alkyl sulphate, an alkoxylated alkyl sulphate, or a mixture thereof. The alkyl sulphate anionic surfactant may be a primary or a secondary alkyl sulphate anionic surfactant, or a mixture thereof, for example sodium lauryl sulfate. The alkoxylated alkyl sulphate may comprise an ethoxylated alkyl sulphate, propoxylated alkyl sulphate, a mixed ethoxylated/propoxylated alkyl sulphate, or a mixture thereof. An ethoxylated alkyl sulphate may have an average degree of ethoxylation of between 0.1 to 5, or between 0.5 and 3. The ethoxylated alkyl sulphate may have an average alkyl chain length of between 8 and 18, more preferably between 10 and 16, most preferably between 12 and 15. The alkyl portion of the ethoxylated alkyl sulphate may include, on average, from 13.7 to about 16 or from 13.9 to 14.6 carbons atoms. At least about 50% or at least about 60% of the AES molecule may include having an alkyl portion having 14 or more carbon atoms, from 14 to 18, or from 14 to 17, or from 14 to 16, or from 14 to 15 carbon atoms.

The alkyl ether carboxylate may be linear or branched. It may have an average carbon chain length of about 10 to about 26, about 10 to about 20, or about 16 to about 18. The alkyl ether carboxylate may have an average level of ethoxylation of about 2 to about 20, about 7 to about 13, about 8 to about 12, or about 9.5 to about 10.5. The acid form or salt form may be used. The alkyl chain may contain one cis or trans double bond. Commercial alkyl ether carboxylates are available, for example, from Kao (Akypo®), Huntsman (Empicol®), and Clariant (Emulsogen®).

The alkyl chain of the alkyl sulphate anionic surfactant may be linear, branched or a mixture thereof. A branched alkyl sulphate anionic surfactant may be a branched primary alkyl sulphate, a branched secondary alkyl sulphate, or a mixture thereof, preferably a branched primary alkyl sulphate, wherein the branching preferably is in the 2-position, or alternatively might be present further down the alkyl chain or could be multi-branched with branches spread over the alkyl chain. The weight average degree of branching of alkyl sulphate anionic surfactant may be from 0% to 100% preferably from 0% to 95%, more preferably from 0% to 60%, most preferably from 0% to 20%. Alternatively, the weight average degree of branching of alkyl sulphate anionic surfactant may be from 70% to 100%, preferably from 80% to 90%. Preferably, the alkyl chain is selected from naturally derived material, synthetically derived material, or a mixture thereof. Preferably, the synthetically derived material comprises oxo-synthesized material, Ziegler-synthesized material, Guerbet-synthesized material, Fischer-Tropsch—synthesized material, iso-alkyl synthesized material, or mixtures thereof, preferably oxo-synthesized material.

Branched 2-alkyl primary alkyl alcohol sulfates and 2-alkyl primary alkyl alcohol ethoxy sulfates having specific alkyl chain length distributions, may provide increased stain removal (particularly in cold water). 2-alkyl branched alcohols (and the 2-alkyl branched alkyl sulfates and 2-alkyl branched alkyl ethoxy sulfates and other surfactants derived from them) are positional isomers, where the location of the hydroxymethyl group (consisting of a methylene bridge (—CH₂— unit) connected to a hydroxy (—OH) group) on the carbon chain varies. Thus, a 2-alkyl branched alkyl alcohol is generally composed of a mixture of positional isomers. Furthermore, it is well known that fatty alcohols, such as 2-alkyl branched alcohols, and surfactants are characterized by chain length distributions. In other words, fatty alcohols and surfactants are generally made up of a blend of molecules having different alkyl chain lengths (though it is possible to obtain single chain-length cuts). Notably, the 2-alkyl primary alcohols described herein, which may have specific alkyl chain length distributions and/or specific fractions of certain positional isomers, cannot be obtained by simply blending commercially available materials. Specifically, the distribution of from about 50% to about 100% by weight surfactants having m+n=11 is not achievable by blending commercially available materials.

The detergent composition may comprise a mixture of surfactant isomers of Formula 14 and surfactants of Formula 15:

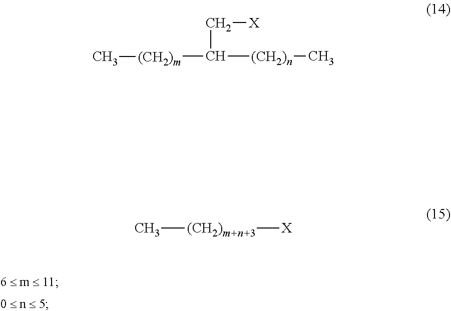

wherein from about 50% to about 100% by weight of the first surfactant are isomers having m+n=11; wherein from about 25% to about 50% of the mixture of surfactant isomers of Formula 14 have n=0; wherein from about 0.001% to about 25% by weight of the first surfactant are surfactants of Formula 15; and wherein X is a hydrophilic moiety.

X may be, for example, neutralized with sodium hydroxide, potassium hydroxide, magnesium hydroxide, lithium hydroxide, calcium hydroxide, ammonium hydroxide, monoethanolamine, diethanolamine, triethanolamine, monoisopropanolamine, diamine, polyamine, primary amine, secondary amine, tertiary amine, amine containing surfactant, or a combination thereof.

X may be selected from sulfates, alkoxylated alkyl sulfates, sulfonates, amine oxides, polyalkoxylates, polyhydroxy moieties, phosphate esters, glycerol sulfonates, polygluconates, polyphosphate esters, phosphonates, sulfosuccinates, sulfosuccaminates, polyalkoxylated carboxylates, glucamides, taurinates, sarcosinates, glycinates, isethionates, dialkanolamides, monoalkanolamides, monoalkanolamide sulfates, diglycolamides, diglycolamide sulfates, glycerol esters, glycerol ester sulfates, glycerol ethers, glycerol ether sulfates, polyglycerol ethers, polyglycerol ether sulfates, sorbitan esters, polyalkoxylated sorbitan esters, ammonioalkanesulfonates, amidopropyl betaines, alkylated quats, alkyated/polyhydroxyalkylated quats, alkylated/polyhydroxylated oxypropyl quats, imidazolines, 2-yl-succinates, sulfonated alkyl esters, sulfonated fatty acids, and mixtures thereof.

The anionic surfactant may also be a biosurfactant. Anionic biosurfactants may include, for example, rhamnolipids. The rhamnolipid may have a single rhamnose sugar ring or two sugar rings.

The detergent composition may also comprise a non-ionic surfactant. A nonionic surfactant may comprise an alcohol alkoxylate, an oxo-synthesized alcohol alkoxylate, a Guerbet alcohol alkoxylate, an alkyl phenol alcohol alkoxylate, an alkylpolyglucoside, or a mixture thereof. Preferably, a non-ionic surfactant may include, for example, alkoxylated alcohol nonionic surfactants, alkyl polyglucoside nonionic surfactants, and mixtures thereof. Preferably, the alkoxylated alcohol non-ionic surfactant is a linear or branched, primary or secondary alkyl alkoxylated non-ionic surfactant, preferably an alkyl alkoxylated non-ionic surfactant, preferably an alkyl ethoxylated nonionic surfactant, preferably comprising on average from about 9 to about 15, preferably from about 10 to about 16, more preferably from about 12 to about 15, carbon atoms in its alkyl chain; and on average from about 5 to about 12, preferably from about 6 to about 10, most preferably from about 7 to about 8 or from about 9 to about 10, units of ethylene oxide per mole of alcohol. For example, a nonionic surfactant can comprises an ethoxylated nonionic surfactant wherein the ethoxylated nonionic surfactant with an average carbon chain length of about 10 to about 16 comprises an ethoxylated nonionic surfactant with an average carbon chain length of about 12 to about 14 and an average level of ethoxylation of about 9 and a second ethoxylated nonionic surfactant with an average carbon chain length of about 14 to about 15 and an average ethoxylation of about 7.

The nonionic surfactant may have the formula R(OC₂H₄)ₙOH, wherein R is selected from the group consisting of aliphatic hydrocarbon radicals containing from about 8 to about 16 carbon atoms and can be linear or branched and the average value of n is from about 5 to about 15. For example, the additional nonionic surfactant may be selected from ethoxylated alcohols having an average of about 12-14 carbon atoms in the alcohol (alkyl) portion and an average degree of ethoxylation of about 7-9 moles of ethylene oxide per mole of alcohol.

Additional non limiting examples include ethoxylated alkyl phenols of the formula R(OC₂H₄)ₙOH, wherein R comprises an alkyl phenyl radicals in which the alkyl groups contain from about 8 to about 12 carbon atoms, and the average value of n is from about 5 to about 15, C₁₂-C₁₈ alkyl ethoxylates, such as, NEODOL® nonionic surfactants from Shell; C₁₄-C₂₂ mid-chain branched alcohols; C₁₄-C₂₂ mid-chain branched alkyl ethoxylates, BAEₓ, wherein x is from 1 to 30. The nonionic ethoxylated alcohol surfactant herein may further comprise residual alkoxylation catalyst, which may be considered residue from the reaction or an impurity. It may further comprise various impurities or by-products of the alkoxylation reaction. The impurities may vary depending on the catalyst used and the conditions of the reaction. Impurities include alkyl ethers, e.g., dialkyl ethers, such as, didodecyl ether, glycols, e.g., diethylene glycol, triethylene glycol, pentaethylene glycol, other polyethylene glycols.

The nonionic ethoxylated alcohol may be a narrow range ethoxylated alcohol. A narrow range ethoxylated alcohol may have the following general formula (I):

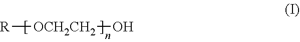

where R is selected from a saturated or unsaturated, linear or branched, C₁₀-C₁₆ alkyl group and where greater than 90% of n is 0≤n≤15. In addition, the average value of n can be between about 4 to about 14, preferably about 6 to about 10, where less than about 10% by weight of the alcohol ethoxylate are ethoxylates having n<7 and between 10% and about 20% by weight of the alcohol ethoxylate are ethoxylates having n=8.

The composition may comprise an average value of n of about 10. The composition may have the following ranges for each of the following n: n=0 of up to 5%, each of n=1, 2, 3, 4, 5 of up to 2%, n=6 of up to 4%, n=7 of up to 10%, n=8 of between 12% and 20%, n=9 of between 15% and 25%, n=10 of between 15% to 30%, n=11 of between 10% and 20%, n=12 of up to 10%, and n>12 at up to 10%. The composition may have n=9 to 10 of between 30% and 70%. The composition may have greater than 50% of its composition made up of n=8 to 11.

R can be selected from a saturated or unsaturated, linear or branched, C10-C16 alkyl group, where the average value of n is between about 6 and about 10. R can also be selected from a saturated or unsaturated, linear or branched, C₈-C₁₆ alkyl group, where greater than 90% of n is 0≤n≤15, and where the average value of n between about 5 to about 10, where less than about 20% by weight of the alcohol ethoxylate are ethoxylates having n<8. R can also be selected from a saturated or unsaturated, linear or branched, C₁₀-C₁₆ alkyl group, where greater than 90% of n is 0≤n≤15, and where the average value of n between about 6 to about 10, where less than about 10% by weight of the alcohol ethoxylate are ethoxylates having n<7 and between 10% and about 20% by weight of the alcohol ethoxylate are ethoxylates having n=8.

The alcohol ethoxylates described herein are typically not single compounds as suggested by their general formula (I), but rather, they comprise a mixture of several homologs having varied polyalkylene oxide chain length and molecular weight. Among the homologs, those with the number of total alkylene oxide units per mole of alcohol closer to the most prevalent alkylene oxide adduct are desirable; homologs whose number of total alkylene oxide units is much lower or much higher than the most prevalent alkylene oxide adduct are less desirable. In other words, a “narrow range” or “peaked” alkoxylated alcohol composition is desirable. A “narrow range” or “peaked” alkoxylated alcohol composition refers to an alkoxylated alcohol composition having a narrow distribution of alkylene oxide addition moles.

A “narrow range” or “peaked” alkoxylated alcohol composition may be desirable for a selected application. Homologs in the selected target distribution range may have the proper lipophilic-hydrophilic balance for a selected application. For example, in the case of an ethoxylated alcohol product comprising an average ratio of 5 ethylene oxide (EO) units per molecule, homologs having a desired lipophilic-hydrophilic balance may range from 2EO to 9EO. Homologs with shorter EO chain length (<2EO) or longer EO chain length (>9EO) may not be desirable for the applications for which a =5 EO/alcohol ratio surfactant is ordinarily selected since such longer and shorter homologs are either too lipophilic or too hydrophilic for the applications utilizing this product. Therefore, it is advantageous to develop an alkoxylated alcohol having a peaked distribution.

The narrow range alkoxylated alcohol compositions of the disclosure may have an average degree of ethoxylation ranging from about 0 to about 15, such as, for example, ranging from about 4 to about 14, from about 5-10, from about 8-11, and from about 6-9. The narrow range alkoxylated alcohol compositions of the disclosure may have an average degree of ethoxylation of 10. The narrow range alkoxylated alcohol compositions of the disclosure may have an average degree of ethoxylation of 9. The narrow range alkoxylated alcohol compositions of the disclosure may have an average degree of ethoxylation of 5.

The alkyl polyglucoside surfactant can be selected from C10-C16 alkyl polyglucoside surfactant. The alkyl polyglucoside surfactant can have a number average degree of polymerization of from 0.1 to 3.0, preferably from 1.0 to 2.0, more preferably from 1.2 to 1.6.

The alkyl polyglucoside surfactant can comprise a blend of short chain alkyl polyglucoside surfactant having an alkyl chain comprising 10 carbon atoms or less, and mid to long chain alkyl polyglucoside surfactant having an alkyl chain comprising greater than 10 carbon atoms to 18 carbon atoms, preferably from 12 to 14 carbon atoms.

Short chain alkyl polyglucoside surfactants have a monomodal chain length distribution between C8-C10, mid to long chain alkyl polyglucoside surfactants have a monomodal chain length distribution between C10-C18, while mid chain alkyl polyglucoside surfactants have a monomodal chain length distribution between C12-C14. In contrast, C8 to C18 alkyl polyglucoside surfactants typically have a monomodal distribution of alkyl chains between C8 and C18, as with C8 to C16 and the like. As such, a combination of short chain alkyl polyglucoside surfactants with mid to long chain or mid chain alkyl polyglucoside surfactants have a broader distribution of chain lengths, or even a bimodal distribution, than non-blended C8 to C18 alkyl polyglucoside surfactants. Preferably, the weight ratio of short chain alkyl polyglucoside surfactant to long chain alkyl polyglucoside surfactant is from 1:1 to 10:1, preferably from 1.5:1 to 5:1, more preferably from 2:1 to 4:1. It has been found that a blend of such short chain alkyl polyglucoside surfactant and long chain alkyl polyglucoside surfactant results in faster dissolution of the detergent solution in water and improved initial sudsing, in combination with improved suds stability.

C10-C16 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation). Glucopon® 215UP is a preferred short chain APG surfactant. Glucopon® 600CSUP is a preferred mid to long chain APG surfactant.

The detergent composition may also comprise an amphoteric surfactant and/or zwitterionic surfactant. Suitable amphoteric or zwitterionic surfactants include amine oxides, and/or betaines. Preferred amine oxides are alkyl dimethyl amine oxide or alkyl amidopropyl dimethyl amine oxide, more preferably alkyl dimethyl amine oxide and especially coco dimethyl amine oxide. Amine oxide may have a linear or mid-branched alkyl moiety. Typical linear amine oxides include water-soluble amine oxides containing one R₄ C₈ to C₁₈ alkyl moiety and 2 R₅ and R₆ moieties selected from the group consisting of C₁ to C₃ alkyl groups and C₁ to C₃ hydroxyalkyl groups. Preferably amine oxide is characterized by Formula 16

R₄—N(R₅)(R₆)O (16)

in which R₄ is a C₈ to C₁₈ alkyl and R₅ and R₆ are selected from the group consisting of methyl, ethyl, propyl, isopropyl, 2-hydroxethyl, 2-hydroxypropyl and 3-hydroxypropyl. The linear amine oxide surfactants in particular may include linear C₁₀-C₁₈ alkyl dimethyl amine oxides and linear C₈-C₁₂ alkoxy ethyl dihydroxy ethyl amine oxides.

Other suitable surfactants include betaines, such as alkyl betaines, alkylamidobetaine, amidazoliniumbetaine, sulfobetaine (sultaines) as well as phosphobetaines, or a combination thereof.

### Perfume

The detergent composition may also comprise a perfume. Perfume may be present, for example, at a level of about 0.2% to about 6.0%, or from about 0.2 to about 5.0%, or from about 0.2 to about 4%, or from about 0.2 to about 3%, or from about 0.2 to about 2.0%.

### Water

The detergent composition also includes water. Water may be present, for example, at a level of about 5% to about 95%, by weight of the composition.

pH

The detergent composition may have a pH of about 5.0 to about 12, preferably 6.0-10.0, more preferably from 8.0 to 10. wherein the pH of the detergent composition is measured as a 10% dilution in demineralized water at 20° C.

### Adjunct Ingredients

Compositions according to various embodiments may comprise on or more adjunct ingredient(s). The non-limiting list of adjuncts provided hereinafter are suitable for use in the instant compositions and may be desirably incorporated in certain embodiments, for example to assist or enhance performance, for treatment of the substrate to be cleaned, or to modify the aesthetics of the composition as is the case with colorants, dyes or the like. Suitable adjunct materials include, but are not limited to, polymers, for example cationic polymers, surfactants, builders, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, additional perfume and perfume delivery systems, structure elasticizing agents, fabric softeners, carriers, hydrotropes, processing aids and/or pigments.

The liquid detergent composition may comprise one or more adjunct ingredients. Adjunct ingredients may include, for example, color care agents; organic solvents; aesthetic dyes; hueing dyes; leuco dyes; opacifiers such as those commercially available under the Acusol tradename, brighteners including FWA49, FWA15, and FWA36; dye transfer inhibitors including PVNO, PVP and PVPVI dye transfer inhibitors; builders including citric acid- and fatty acids; other chelants (i.e., chelants other than those according to Formula 7); enzymes; perfume capsules; preservatives; antioxidants including sulfite salts such as potassium sulphite or potassium bisulphite salts and those commercially available under the Ralox brand name; antibacterial and anti-viral agents including 4.4′-dichloro 2-hydroxydiphenyl ether such as Tinosan HP100 available from the BASF company; anti-mite actives such as benzyl benzoate; structuring agents including hydrogenated castor oil; silicone based anti-foam materials; electrolytes including inorganic electrolytes such as sodium chloride, potassium chloride, magnesium chloride, and calcium chloride, and related sodium, potassium, magnesium and calcium sulphate salts, as well as organic electrolytes such as sodium, potassium, magnesium and calcium salts of carbonate, bicarbonate, carboxylates such as formate, citrate and acetate; pH trimming agents including sodium hydroxide, hydrogen chloride, and alkanolamines including monoethanolamine, diethanolamine, triethanolamine, and monoisopropanolamine; a probiotic; a hygiene agent such as zinc ricinoleate, thymol, quaternary ammonium salts such as Bardac®, polyethylenimines (such as Lupasol® from BASF) and zinc complexes thereof, silver and silver compounds, a cationic biocide including octyl decyl dimethyl ammonium chloride, dioctyl dimethyl ammonium chloride, didecyl dimethyl ammonium chloride, dispersant, cleaning polymer, glucan, or a mixture thereof.

The organic solvent may include an alcohol and/or a polyol. For example, the organic solvent may comprise ethanol, propanol, isopropanol, a sugar alcohol, a glycol, a glycol ether, or a combination thereof. The organic solvent may comprise polyethylene glycol, especially low molecular weight polyethylene glycols such as PEG 200 and PEG 400; diethylene glycol; glycerol; 1,2-propanediol; polypropylene glycol including dipropylene glycol and tripropylene glycol and low molecular weight polypropylene glycols such as PPG400; or a mixture thereof.

The enzyme may comprise, for example, protease, amylase, cellulase, mannanase, lipase, xyloglucanase, pectate lyase, nuclease enzyme, or a mixture thereof.

The composition may comprise one or more polymers. Examples are optionally modified carboxymethylcellulose, modified polyglucans, poly(vinyl-pyrrolidone), poly(ethylene glycol), poly(vinyl alcohol), poly(vinylpyridine-N-oxide), poly(vinylimidazole), polycarboxylates such as polyacrylates, maleic/acrylic acid copolymers and lauryl methacrylate/acrylic acid co-polymers.

The composition may comprise one or more amphiphilic cleaning polymers. Such polymers have balanced hydrophilic and hydrophobic properties such that they remove grease particles from fabrics and surfaces. Suitable amphiphilic alkoxylated grease cleaning polymers comprise a core structure and a plurality of alkoxylate groups attached to that core structure. These may comprise alkoxylated polyalkylenimines, especially ethoxylated polyethylene imines or polyethyleneimines having an inner polyethylene oxide block and an outer polypropylene oxide block. Typically, these may be incorporated into the compositions of the invention in amounts of from 0.005 to 10 wt %, generally from 0.5 to 8 wt %.

The composition may comprise a zwitterionic polyamine that is a modified hexamethylenediamine. The modification of the hexamethylenediamine includes: (1) one or two alkoxylation modifications per nitrogen atom of the hexamethylenediamine. The alkoxylation modification consisting of the replacement of a hydrogen atom on the nitrogen of the hexamethylenediamine by a (poly)alkoxylene chain having an average of about 1 to about 40 alkoxy moieties per modification, wherein the terminal alkoxy moiety of the alkoxylene chain is capped with hydrogen, a C₁-C₄ alkyl, sulfates, carbonates, or mixtures thereof; (2) a substitution of one C₁-C₄ alkyl moiety and one or two alkoxylation modifications per nitrogen atom of the hexamethylenediamine. The alkoxylation modification consisting of the replacement of a hydrogen atom by a (poly)alkoxylene chain having an average of about 1 to about 40 alkoxy moieties per modification wherein the terminal alkoxy moiety of the alkoxylene chain is capped with hydrogen, a C₁-C₄ alkyl or mixtures thereof; or (3) a combination thereof.

Other suitable polymers include amphiphilic graft copolymers. Preferred amphiphilic graft co-polymer(s) comprise (i) polyethyelene glycol backbone; and (ii) and at least one pendant moiety selected from polyvinyl acetate, polyvinyl alcohol and mixtures thereof. An example of amphiphilic graft co-polymer is Sokalan HP22, supplied from BASF. Other suitable polymers include random graft copolymers, preferably a polyvinyl acetate grafted polyethylene oxide copolymer having a polyethylene oxide backbone and multiple polyvinyl acetate side chains. The molecular weight of the polyethylene oxide backbone is preferably about 6000 and the weight ratio of the polyethylene oxide to polyvinyl acetate is about 40 to 60 and less than or equal to 1 grafting point per 50 ethylene oxide units. Typically, these are incorporated into the compositions of the invention in amounts from 0.005 to 10 wt %, more usually from 0.05 to 8 wt %.

The composition may comprise one or more soil release polymers. Examples include soil release polymers having a structure as defined by one of the following Formula (17), (18) or (19):

[(OCHR₇—CHR₈)_{g}—O—OC—Ar—CO—]_{d} (17)

—[(OCHR₉—CHR₁₀)ₙ—O—OC-sAr—CO—]ₑ (18)

—[(OCHR₁₁—CHR₁₂)ᵢ—OR₁₃]_{f} (19)
wherein:
d, e and f are from 1 to 50;
g, h and i are from 1 to 200;
Ar is a 1,4-substituted phenylene;
sAr is 1,3-substituted phenylene substituted in position 5 with SO₃Me;
Me is Na, Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;
R₇, R₈, R₉, R₁₀, R₁₁ and R₁₂ are independently selected from H or C₁-C₁₈ n- or iso-alkyl; and
R₁₃ is a linear or branched C₁-C₁₅ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

Suitable soil release polymers are polyester soil release polymers such as Repel-o-tex polymers, including Repel-o-tex SF, SF-2 and SRP6 supplied by Rhodia. Other suitable soil release polymers include Texcare polymers, including Texcare SRA100, SRA300, SRN100, SRN170, SRN240, SRN260, SRN300 and SRN325 supplied by Clariant. Other suitable soil release polymers are Marloquest polymers, such as Marloquest SL supplied by Sasol.

Known polymeric soil release agents, hereinafter “SRA” or “SRA's”, may optionally be employed in the present detergent compositions. If utilized, SRA's will generally comprise from 0.01% to 10.0%, typically from 0.1% to 5%, preferably from 0.2% to 3.0% by weight, of the composition.

SRA's may include, for example, a variety of charged, e.g., anionic or even cationic (see U.S. Pat. No. 4,956,447), as well as noncharged monomer units and structures may be linear, branched or even star-shaped. Examples of SRAs are described in U.S. Pat. Nos. 4,968,451; 4,711,730; 4,721,580; 4,702,857; 4,877,896; 3,959,230; 3,893,929; 4,000,093; 5,415,807; 4,201,824; 4,240,918; 4,525,524; 4,201,824; 4,579,681; and 4,787,989.

The composition may comprise a carboxylate polymer, such as a maleate/acrylate random copolymer or polyacrylate homopolymer. Suitable carboxylate polymers include: polyacrylate homopolymers having a molecular weight of from 4,000 Da to 9,000 Da; maleate/acrylate random copolymers having a molecular weight of from 50,000 Da to 100,000 Da, or from 60,000 Da to 80,000 Da.

Alternatively, these materials may comprise polyacrylates having one ethoxy side-chain per every 7-8 acrylate units. The side-chains are of the formula —(CH₂CH₂O)ₘ(CH₂)ₙCH₃ wherein m is 2-3 and n is 6-12. The side-chains are ester-linked to the polyacrylate “backbone” to provide a “comb” polymer type structure. The molecular weight may vary, but is typically in the range of about 2000 to about 50,000. Such alkoxylated polycarboxylates may comprise from about 0.05% to about 10%, by weight, of the compositions herein.

Such carboxylate-based polymers may advantageously be utilized at levels from about 0.1% to about 7%, by weight, in the compositions herein. Suitable polymeric dispersing agents include carboxylate polymer such as a maleate/acrylate random copolymer or polyacrylate homopolymer. Preferably the carboxylate polymer is a polyacrylate homopolymer having a molecular weight of from 4,000 Daltons to 9,000 Daltons, or maleate/acrylate copolymer with a molecular weight 60,000 Daltons to 80,000 Daltons. Polymeric polycarboxylates and polyethylene glycols, may also be used. Polyalkylene glycol-based graft polymer may prepared from the polyalkylene glycol-based compound and the monomer material, wherein the monomer material includes the carboxyl group-containing monomer and the optional additional monomer(s). Optional additional monomers not classified as a carboxyl group-containing monomer include sulfonic acid group-containing monomers, amino group-containing monomers, allylamine monomers, quaternized allylamine monomers, N vinyl monomers, hydroxyl group-containing monomers, vinylaryl monomers, isobutylene monomers, vinyl acetate monomers, salts of any of these, derivatives of any of these, and mixtures thereof.

The composition may comprise alkoxylated polyamines. Such materials include but are not limited to ethoxylated polyethyleneimine, ethoxylated hexamethylene diamine, and sulfated versions thereof. Polypropoxylated derivatives are also included. A wide variety of amines and polyaklyeneimines may be alkoxylated to various degrees, and optionally further modified to provide the abovementioned benefits. A useful example is 600 g/mol polyethyleneimine core ethoxylated to 20 EO groups per NH. A preferred ethoxylated polyethyleneimine is PE-20 available from BASF.

Useful alkoxylated polyamine based polymers include the alkoxylated polyethylene imine type where said alkoxylated polyalkyleneimine has a polyalkyleneimine core with one or more side chains bonded to at least one nitrogen atom in the polyalkyleneimine core, wherein said alkoxylated polyalkyleneimine has an empirical Formula (20) of

(PEI)ⱼ-(EO)ₖ—R₁₄, (20)

wherein j is the average number-average molecular weight (MW_{PEI}) of the polyalkyleneimine core of the alkoxylated polyalkyleneimine and is in the range of from 100 to 100,000 Daltons, wherein k is the average degree of ethoxylation in said one or more side chains of the alkoxylated polyalkyleneimine and is in the range of from 5 to 40, and wherein R₁₄ is independently selected from the group consisting of hydrogen, C₁-C₄ alkyls, and combinations thereof.

Other suitable alkoxylated polyalkyleneimine include those wherein said alkoxylated polyalkyleneimine has a polyalkyleneimine core with one or more side chains bonded to at least one nitrogen atom in the polyalkyleneimine core, wherein the alkoxylated polyalkyleneimine has an empirical Formula (21) of

(PEI)ₒ-(EO)ₘ(PO)ₙ—R₁₅ or (PEI)ₒ—(PO)ₙ(EO)ₘ—R₁₅, (21)

wherein o is the average number-average molecular weight (MW_{PEI}) of the polyalkyleneimine core of the alkoxylated polyalkyleneimine and is in the range of from 100 to 100,000 Daltons, wherein m is the average degree of ethoxylation in said one or more side chains of the alkoxylated polyalkyleneimine which ranges from 10 to 50, wherein n is the average degree of propoxylation in said one or more side chains of the alkoxylated polyalkyleneimine which ranges from 1 to 50, and wherein R₁₅ is independently selected from the group consisting of hydrogen, C₁-C₄ alkyls, and combinations thereof.

Cellulosic polymers may be used according to the invention. Suitable cellulosic polymers are selected from alkyl cellulose, alkyl alkoxyalkyl cellulose, carboxyalkyl cellulose, alkyl carboxyalkyl cellulose, sulphoalkyl cellulose, more preferably selected from carboxymethyl cellulose, methyl cellulose, methyl hydroxyethyl cellulose, methyl carboxymethyl cellulose, and mixtures thereof. Suitable carboxymethyl celluloses have a degree of carboxymethyl substitution from 0.5 to 0.9 and a molecular weight from 100,000 Da to 300,000 Da. Suitable carboxymethyl celluloses have a degree of substitution greater than 0.65 and a degree of blockiness greater than 0.45, e.g. as described in WO09/154933.

The consumer products of the present invention may also include one or more cellulosic polymers including those selected from alkyl cellulose, alkylalkoxyalkyl cellulose, carboxyalkyl cellulose, alkyl carboxyalkyl cellulose. In one aspect, the cellulosic polymers are selected from the group comprising carboxymethyl cellulose, methyl cellulose, methyl hydroxyethyl cellulose, methyl carboxymethyl cellulose, and mixtures thereof. In one aspect, the carboxymethyl cellulose has a degree of carboxymethyl substitution from 0.5 to 0.9 and a molecular weight from 100,000 Da to 300,000 Da. Examples of carboxymethylcellulose polymers are Carboxymethyl cellulose commercially sold by CPKelko as Finnfix®GDA, hydrophobically modified carboxymethyl cellulose, for example the alkyl ketene dimer derivative of carboxymethylcellulose sold commercially by CPKelco as Finnfix®SH1, or the blocky carboxymethylcellulose sold commercially by CPKelco as Finnfix®V.

Cationic polymers may also be used according to the invention. Suitable cationic polymers will have cationic charge densities of at least 0.5 meq/gm, in another embodiment at least 0.9 meq/gm, in another embodiment at least 1.2 meq/gm, in yet another embodiment at least 1.5 meq/gm, but in one embodiment also less than 7 meq/gm, and in another embodiment less than 5 meq/gm, at the pH of intended use of the composition, which pH will generally range from pH 3 to pH 9, in one embodiment between pH 4 and pH 8. Herein, “cationic charge density” of a polymer refers to the ratio of the number of positive charges on the polymer to the molecular weight of the polymer. The average molecular weight of such suitable cationic polymers will generally be between 10,000 and 10 million, in one embodiment between 50,000 and 5 million, and in another embodiment between 100,000 and 3 million.

Suitable cationic polymers for use in the compositions herein may contain cationic nitrogen-containing moieties such as quaternary ammonium or cationic protonated amino moieties. Any anionic counterions may be used in association with the cationic polymers so long as the polymers remain soluble in water, in the composition, or in a coacervate phase of the composition, and so long as the counterions are physically and chemically compatible with the essential components of the composition or do not otherwise unduly impair product performance, stability or aesthetics. Nonlimiting examples of such counterions include halides (e.g., chloride, fluoride, bromide, iodide), sulfate and methylsulfate.

Nonlimiting examples of such polymers are described in the CTFA Cosmetic Ingredient Dictionary, 3rd edition, edited by Estrin, Crosley, and Haynes, (The Cosmetic, Toiletry, and Fragrance Association, Inc., Washington, D.C. (1982)).

Especially useful cationic polymers which may be used include wherein said cationic polymer comprises a polymer selected from the group consisting of cationic celluloses, cationic guars, poly(acrylamide-co-diallyldimethylammonium chloride), poly(acrylamide-co-diallyldimethylammonium chloride-co-acrylic acid), poly(acrylamide-co-methacryloamidopropyl-pentamethyl-1,3-propylene-2-ol-ammonium dichloride), poly(acrylamide-co-N,N-dimethylaminoethyl acrylate) and its quaternized derivatives, poly(acrylamide-co-N,N-dimethylaminoethyl methacrylate) and its quaternized derivatives, poly(acrylamide-methacrylamidopropyltrimethyl ammonium chloride), poly(acrylamide-methacrylamidopropyltrimethyl ammonium chloride-co-acrylic acid), poly(diallyldimethyl ammonium chloride), poly(diallyldimethylammonium chloride-co-acrylic acid), poly(ethyl methacrylate-co-oleyl methacrylate-co-diethylaminoethyl methacrylate) and its quaternized derivatives, poly(ethyl methacrylate-co-dimethylaminoethyl methacrylate) and its quaternized derivatives, poly(hydroxpropylacrylate-co-methacrylamidopropyltrimethylammonium chloride) and its quaternized derivatives, poly(hydroxyethylacrylate-co-dimethyl aminoethyl methacrylate) and its quaternized derivatives, poly(methylacrylamide-co-dimethylaminoethyl acrylate) and its quaternized derivatives, poly(methacrylate-co-methacrylamidopropyltrimethyl ammonium chloride), poly(vinylformamide-co-acrylic acid-co-diallyldimethylammonium chloride), poly(vinylformamide-co-diallyldimethylammonium chloride), poly(vinylpyrrolidone-co-acrylamide-co-vinyl imidazole) and its quaternized derivatives, poly(vinylpyrrolidone-co-dimethylaminoethyl methacrylate) and its quaternized derivatives, poly(vinylpyrrolidone-co-methacrylamide-co-vinyl imidazole) and its quaternized derivatives, poly(vinylpyrrolidone-co-vinyl imidazole) and its quaternized derivatives, polyethyleneimine and including its quaternized derivatives, and mixtures thereof

Other suitable cationic polymers for use in the composition include polysaccharide polymers, cationic guar gum derivatives, quaternary nitrogen-containing cellulose ethers, synthetic polymers, copolymers of etherified cellulose, guar and starch. When used, the cationic polymers herein are either soluble in the composition or are soluble in a complex coacervate phase in the composition formed by the cationic polymer and the anionic, amphoteric and/or zwitterionic surfactant component described hereinbefore. Complex coacervates of the cationic polymer may also be formed with other charged materials in the composition.

Suitable cationic polymers are described in U.S. Pat. Nos. 3,962,418; 3,958,581; and U.S. Publication No. 2007/0207109A1.

The composition may comprise one or more dye transfer inhibiting agents. In one embodiment of the invention the inventors have surprisingly found that compositions comprising polymeric dye transfer inhibiting agents in addition to the specified dye give improved performance. This is surprising because these polymers prevent dye deposition. Suitable dye transfer inhibitors include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. Suitable examples include PVP-K15, PVP-K30, ChromaBond S-400, ChromaBond S-403E and Chromabond S-100 from Ashland Aqualon, and Sokalan HP165, Sokalan HP50, Sokalan HP53, Sokalan HP59, Sokalan® HP 56K, Sokalan® HP 66 from BASF. The dye control agent may be selected from (i) a sulfonated phenol/formaldehyde polymer; (ii) a urea derivative; (iii) polymers of ethylenically unsaturated monomers, where the polymers are molecularly imprinted with dye; (iv) fibers consisting of water-insoluble polyamide, wherein the fibers have an average diameter of not more than about 2 μm; (v) a polymer obtainable from polymerizing benzoxazine monomer compounds; and (vi) combinations thereof. Other suitable DTIs are as described in WO2012/004134. When present in a subject composition, the dye transfer inhibiting agents may be present at levels from about 0.0001% to about 10%, from about 0.01% to about 5% or even from about 0.1% to about 3% by weight of the composition.

Examples of water soluble polymers include but are not limited to polyvinyl alcohols (PVA), modified PVAs; polyvinyl pyrrolidone; PVA copolymers such as PVA/polyvinyl pyrrolidone and PVA/polyvinyl amine; partially hydrolyzed polyvinyl acetate; polyalkylene oxides such as polyethylene oxide; polyethylene glycols; acrylamide; acrylic acid; cellulose, alkyl cellulosics such as methyl cellulose, ethyl cellulose and propyl cellulose; cellulose ethers; cellulose esters; cellulose amides; polyvinyl acetates; polycarboxylic acids and salts; polyaminoacids or peptides; polyamides; polyacrylamide; copolymers of maleic/acrylic acids; polysaccharides including starch, modified starch; gelatin; alginates; xyloglucans, other hemicellulosic polysaccharides including xylan, glucuronoxylan, arabinoxylan, mannan, glucomannan and galactoglucomannan; and natural gums such as pectin, xanthan, and carrageenan, locus bean, arabic, tragacanth; and combinations thereof.

The composition may comprise a fabric shading agent. Suitable fabric shading agents include dyes, dye-clay conjugates, and pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof. Preferred dyes include alkoxylated azothiophenes, Solvent Violet 13, Acid Violet 50 and Direct Violet 9.

### Encapsulates

A composition may comprise an encapsulate. The composition may comprise, for example, from about 0.05% to about 5%, or from about 0.05% to about 5%, or from about 0.1% to about 5%, or from about 0.2% to about 2%, by weight of the composition, of encapsulates. The composition may comprise a sufficient amount of encapsulates to provide from about 0.05% to about 10%, or from about 0.1% to about 5%, or from about 0.1% to about 2%, by weight of the composition, of perfume to the composition. The encapsulate may comprise a shell and a core. The core may be surrounded by the shell.

When discussing herein the amount or weight percentage of the encapsulates, it is meant the sum of the shell material and the core material.

The encapsulates may have a volume weighted median encapsulate size from about 0.5 microns to about 100 microns, or even 10 to 100 microns, preferably from about 1 micron to about 60 microns, or even 10 microns to 50 microns, or even 20 microns to 45 microns, or alternatively 20 microns to 60 microns.

### Single Unit Dose (SUD) Detergent Composition

According to various embodiments, any of the compositions described herein may be disposed within water-soluble single unit dose (SUD) pouches, as described in U.S. Pat. No. 10,513,588 B2 to Friedrich et al., titled Water-Soluble Polyvinyl Alcohol Film With Plasticizer Blend, Related Methods, And Related Articles, which is incorporated by reference in its entirety.

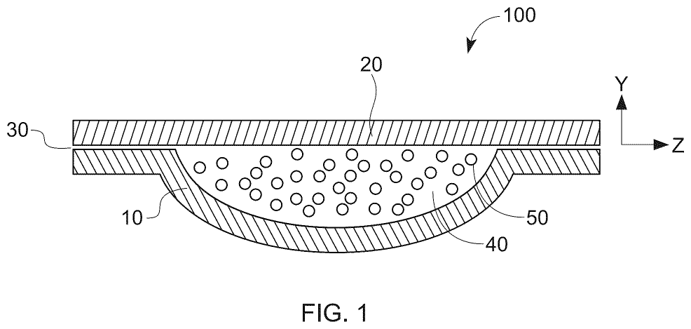

The SUD packets and pouches may include at least one sealed compartment that may be filled with active components such as detergents, to make measured dose pouches. The pouches may comprise a single compartment or multiple compartments. FIG. 1 illustrates an article in which a water-soluble pouch 100 is formed from water-soluble polymer films 10, 20 sealed at an interface 30. One or both of the films 10, 20 include the PVOH polymer and first, second, and third plasticizers. The films 10, 20 define an interior pouch container volume 40 which contains any desired composition 50 for release into an aqueous environment. The composition 50 is not particularly limited, for example including any of the variety of cleaning compositions described below. In embodiments comprising multiple compartments (not shown), each compartment may contain identical and/or different compositions. In turn, the compositions may take any suitable form including, but not limited to liquid, solid and combinations thereof (e.g. a solid suspended in a liquid). In some embodiments, the pouches comprises a first, second and third compartment, each of which respectively contains a different first, second, and third composition.

SUD packets and pouches may be made from water-soluble films including a polyvinyl alcohol (PVOH) polymer and a combination of plasticizers. The water-soluble films may include a polyvinyl alcohol (PVOH) polymer and a combination of at least three plasticizers.

The polyvinyl alcohol (PVOH) polymer may comprise one or more PVOH homopolymers, one or more PVOH copolymers, and combinations thereof. The PVOH polymer of the water-soluble film is not particularly limited and it may include a single PVOH homopolymer, a single PVOH copolymer, or a blend of PVOH homopolymers, copolymers, or combinations thereof. In some aspects, the water-soluble film may include a water-soluble polymer which is other than a PVOH polymer. In one class of embodiments, the PVOH polymer will be a partially or fully hydrolyzed PVOH homopolymer including vinyl alcohol monomer units and optionally vinyl acetate monomer units. In another type of embodiment, the PVOH polymer will be a partially or fully hydrolyzed PVOH copolymer including an anionic monomer unit, a vinyl alcohol monomer unit, and optionally a vinyl acetate monomer unit. In various embodiments, the anionic monomer may be one or more of vinyl acetic acid, maleic acid, monoalkyl maleate, dialkyl maleate, monomethyl maleate, dimethyl maleate, maleic anyhydride, fumaric acid, monoalkyl fumarate, dialkyl fumarate, monomethyl fumarate, dimethyl fumarate, fumaric anyhydride, itaconic acid, monomethyl itaconate, dimethyl itaconate, itaconic anhydride, vinyl sulfonic acid, allyl sulfonic acid, ethylene sulfonic acid, 2-acrylamido-1-methylpropanesulfonic acid, 2-acrylamido-2-methylpropanesulfonic acid, 2-methylacrylamido-2-methylpropanesulfonic acid, 2-sulfoethyl acrylate, alkali metal salts of the foregoing (e.g., sodium, potassium, or other alkali metal salts), esters of the foregoing (e.g., methyl, ethyl, or other C1-C4 or C6 alkyl esters), and combinations thereof (e.g., multiple types of anionic monomers or equivalent forms of the same anionic monomer). For example, the anionic monomer may include one or more acrylamido methylpropanesulfonic acids (e.g., 2-acrylamido-1-methylpropanesulfonic acid, 2-acrylamido-2-methylpropanesulfonic acid, 2-methylacrylamido-2-methylpropanesulfonic acid) and alkali metal salts thereof (e.g., sodium salts). Similarly, the anionic monomer may include one or more of monomethyl maleate and alkali metal salts thereof (e.g., sodium salts). Examples of non-PVOH water-soluble polymers include polyethyleneimines, polyvinyl pyrrolidones, polyalkylene oxides, polyacrylamides, cellulose ethers, cellulose esters, cellulose amides, polyvinyl acetates, polyamides, gelatines, methylcelluloses, carboxymethylcelluloses and salts thereof, dextrins, ethylcelluloses, hydroxyethyl celluloses, hydroxypropyl methylcelluloses, maltodextrins, starches, modified starches, guar gum, gum Acacia, xanthan gum, carrageenan, and polyacrylates and salts thereof.

The combination of plasticizers may include dipropylene glycol as a first plasticizer, a sugar alcohol (e.g. sorbitol) as a second plasticizer, and a polyol (e.g. glycerin) as a third plasticizer. The sugar alcohol plasticizer may be isomalt, maltitol, sorbitol, xylitol, erythritol, adonitol, dulcitol, pentaerythritol, or mannitol, for example. In a particular aspect, the sugar alcohol plasticizer may be sorbitol or a sorbitol-containing plasticizer such as isomalt. The polyol plasticizer may be glycerin, diglycerin, ethylene glycol, diethylene glycol, triethyleneglycol, tetraethylene glycol, a polyethylene glycol up to 400 MW, neopentyl glycol, propylene glycol, 1,3-propanediol, 2-methyl-1,3-propanediol, trimethylolpropane, or a polyether polyol, for example. In a particular aspect, the polyol plasticizer may be glycerin, propylene glycol, or 1,3-propanediol, for example glycerin. In one class of embodiments, the water-soluble film includes the polyvinyl alcohol (PVOH) polymer and a plasticizer blend including dipropylene glycol as the first plasticizer, sorbitol as the second plasticizer, and glycerin as the third plasticizer.

In some embodiments, the water-soluble film may include at least one plasticizer (e.g., as the second plasticizer, the third plasticizer, or otherwise) which is generally solid at room temperature and/or common use, storage, or transportation temperatures, for example a plasticizer which is solid in a range of about 10° C. or 20° C. to about 30° C., 40° C., or 50° C. and/or has a melting point above such range (e.g., a melting point below common film-formation process temperature such as casting, but above common use, storage, or transportation temperatures). Examples of such solid plasticizers include sorbitol (95° C. melting point) and trimethylolpropane (58° C. melting point). Additionally or alternatively, the water-soluble film may include at least one plasticizer (e.g., as the second plasticizer, the third plasticizer, or otherwise) which is generally liquid at room temperature and/or common use, storage, or transportation temperatures, for example which is liquid in a range of about 10° C. or 20° C. to about 30° C., 40° C., or 50° C. and/or has a melting point below such range.

In some examples a water-soluble unit dose article comprises at least one water-soluble film orientated to create at least one unit dose internal compartment, wherein the at least one unit dose internal compartment comprises a detergent composition. The water-soluble film and the detergent composition are described in more detail below.

In some examples the consumer product comprises a container and at least one water-soluble unit dose article, in some cases at least two water-soluble unit dose articles, in some cases at least 20 water-soluble unit dose articles, in some cases at least 30 water-soluble unit dose articles. A water-soluble unit dose article is in some examples in the form of a pouch. A water-soluble unit dose article comprises in some examples a unitary dose of a composition as a volume sufficient to provide a benefit in an end application. The water-soluble unit dose article comprises in some examples one water-soluble film shaped such that the unit-dose article comprises at least one internal compartment surrounded by the water-soluble film. The at least one compartment comprises a cleaning composition. The water-soluble film is sealed such that the cleaning composition does not leak out of the compartment during storage. However, upon addition of the water-soluble unit dose article to water, the water-soluble film dissolves and releases the contents of the internal compartment into the wash liquor.

The unit dose article may comprise more than one compartment, at least two compartments, or at least three compartments, or at least four compartments, or even at least five compartments. The compartments may be arranged in superposed orientation, i.e. one positioned on top of the other. Alternatively, the compartments may be positioned in a side-by-side orientation, i.e. one orientated next to the other. The compartments may be orientated in a ‘tyre and rim’ arrangement, i.e. a first compartment is positioned next to a second compartment, but the first compartment at least partially surrounds the second compartment, but does not completely enclose the second compartment. Alternatively, one compartment may be completely enclosed within another compartment. In some examples the unit dose article comprises at least two compartments, one of the compartments being smaller than the other compartment. In some examples the unit dose article comprises at least three compartments, two of the compartments may be smaller than the third compartment, and in some examples the smaller compartments being superposed on the larger compartment. The superposed compartments are in some examples orientated side-by-side. In some examples each individual unit dose article may have a weight of between 10 g and 40 g, or even between 15 g and 35 g. The water soluble film may be soluble or dispersible in water. Prior to be being formed into a unit dose article, the water-soluble film has in some examples a thickness of from 20 to 150 micron, in other examples 35 to 125 micron, in further examples 50 to 110 micron, in yet further examples about 76 micron. Example water soluble film materials comprise polymeric materials. The film material can, for example, be obtained by casting, blow-moulding, extrusion or blown extrusion of the polymeric material. In some examples, the water-soluble film comprises polyvinyl alcohol homopolymer or polyvinyl alcohol copolymer, for example a blend of polyvinylalcohol homopolymers and/or polyvinylalcohol copolymers, wherein the polyvinyl alcohol copolymers preferably are selected from sulphonated and carboxylated anionic polyvinylalcohol copolymers especially carboxylated anionic polyvinylalcohol copolymers, for example a blend of a polyvinylalcohol homopolymer and a carboxylated anionic polyvinylalcohol copolymer, alternatively a blend of two or more preferably two polyvinyl alcohol homopolymers. In another example the water-soluble film comprises a single polyvinyl alcohol polymer, more preferably a carboxylated anionic polyvinylalcohol copolymer. In some examples water soluble films are those supplied by Monosol under the trade references M8630, M8900, M8779, M8310. In some examples the film may be opaque, transparent or translucent. The film may comprise a printed area. The area of print may be achieved using techniques such as flexographic printing or inkjet printing. The film may comprise an aversive agent, for example a bittering agent. Suitable bittering agents include, but are not limited to, naringin, sucrose octaacetate, quinine hydrochloride, denatonium benzoate, or mixtures thereof. Example levels of aversive agent include, but are not limited to, 1 to 5000 ppm, 100 to 2500 ppm, or 250 to 2000 ppm. The water-soluble film or water-soluble unit dose article or both may be coated with a lubricating agent. In some examples, the lubricating agent is selected from talc, zinc oxide, silicas, siloxanes, zeolites, silicic acid, alumina, sodium sulphate, potassium sulphate, calcium carbonate, magnesium carbonate, sodium citrate, sodium tripolyphosphate, potassium citrate, potassium tripolyphosphate, calcium stearate, zinc stearate, magnesium stearate, starch, modified starches, clay, kaolin, gypsum, cyclodextrins or mixtures thereof.

In some examples the detergent product comprises a detergent composition. The detergent composition may be a laundry detergent composition, an automatic dishwashing composition, a hard surface cleaning composition, or a combination thereof. The detergent composition may comprise a solid, a liquid or a mixture thereof. The term liquid includes a gel, a solution, a dispersion, a paste, or a mixture thereof. The solid may be a powder. By powder we herein mean that the detergent composition may comprise solid particulates or may be a single homogenous solid. In some examples, the powder detergent composition comprises particles. This means that the powder detergent composition comprises individual solid particles as opposed to the solid being a single homogenous solid. The particles may be free-flowing or may be compacted. A laundry detergent composition can be used in a fabric hand wash operation or may be used in an automatic machine fabric wash operation, for example in an automatic machine fabric wash operation. Example laundry detergent compositions comprise a non-soap surfactant, wherein the non-soap surfactant comprises an anionic non-soap surfactant and a non-ionic surfactant. In some examples, the laundry detergent composition comprises between 10% and 60%, or between 20% and 55% by weight of the laundry detergent composition of the non-soap surfactant. Example weight ratio of non-soap anionic surfactant to nonionic surfactant are from 1:1 to 20:1, from 1.5:1 to 17.5:1, from 2:1 to 15:1, or from 2.5:1 to 13:1. Example non-soap anionic surfactants comprises linear alkylbenzene sulphonate, alkyl sulphate anionic surfactant or a mixture thereof. Example weight ratio of linear alkylbenzene sulphonate to alkyl sulphate anionic surfactant are from 1:2 to 9:1, from 1:1 to 7:1, from 1:1 to 5:1, or from 1:1 to 4:1. Example linear alkylbenzene sulphonates are C₁₀-C₁₆ alkyl benzene sulfonic acids, or C₁₁-C₁₄ alkyl benzene sulfonic acids. By ‘linear’, we herein mean the alkyl group is linear. Example alkyl sulphate anionic surfactant may comprise alkoxylated alkyl sulphate or non-alkoxylated alkyl sulphate or a mixture thereof. Example alkoxylated alkyl sulphate anionic surfactant comprise an ethoxylated alkyl sulphate anionic surfactant. Example alkyl sulphate anionic surfactant may comprise an ethoxylated alkyl sulphate anionic surfactant with a mol average degree of ethoxylation from 1 to 5, from 1 to 3, or from 2 to 3. Example alkyl sulphate anionic surfactant may comprise a non-ethoxylated alkyl sulphate and an ethoxylated alkyl sulphate wherein the mol average degree of ethoxylation of the alkyl sulphate anionic surfactant is from 1 to 5, from 1 to 3, or from 2 to 3. Example alkyl fraction of the alkyl sulphate anionic surfactant are derived from fatty alcohols, oxo-synthesized alcohols, Guerbet alcohols, or mixtures thereof. In some examples, the laundry detergent composition comprises between 10% and 50%, between 15% and 45%, between 20% and 40%, or between 30% and 40% by weight of the laundry detergent composition of the non-soap anionic surfactant. In some examples, the non-ionic surfactant is selected from alcohol alkoxylate, an oxo-synthesised alcohol alkoxylate, Guerbet alcohol alkoxylates, alkyl phenol alcohol alkoxylates, or a mixture thereof. In some examples, the laundry detergent composition comprises between 0.01% and 10%, between 0.01% and 8%, between 0.1% and 6%, or between 0.15% and 5% by weight of the liquid laundry detergent composition of a non-ionic surfactant. In some examples, the laundry detergent composition comprises between 1.5% and 20%, between 2% and 15%, between 3% and 10%, or between 4% and 8% by weight of the laundry detergent composition of soap, in some examples a fatty acid salt, in some examples an amine neutralized fatty acid salt, wherein in some examples the amine is an alkanolamine for example selected from monoethanolamine, diethanolamine, triethanolamine or a mixture thereof, in some examples monoethanolamine. In some examples, the laundry detergent composition is a liquid laundry detergent composition. In some examples the liquid laundry detergent composition comprises less than 15%, or less than 12% by weight of the liquid laundry detergent composition of water. In some examples, the laundry detergent composition is a liquid laundry detergent composition comprising a non-aqueous solvent selected from 1,2-propanediol, dipropylene glycol, tripropyleneglycol, glycerol, sorbitol, polyethylene glycol or a mixture thereof. In some examples, the liquid laundry detergent composition comprises between 10% and 40%, or between 15% and 30% by weight of the liquid laundry detergent composition of the non-aqueous solvent. In some examples, the laundry detergent composition comprises a perfume. In some examples, the laundry detergent composition comprises an adjunct ingredient which can be selected from the group comprising builders including citrate, (encapsulated) enzymes including but not limited to proteases, amylases, lipases, cellulases, mannanases, xyloglucanases, DNA'ses, and mixtures thereof, bleach, bleach catalyst, aesthetic dye, hueing dye, brightener, cleaning polymers including alkoxylated polyamines and polyethyleneimines, soil release polymers, fabric conditioning polymers including Polyquaternium 10 (CathEC), further surfactant including amine oxide and solvent, chelants including aminocarboxylate and aminophosphonate chelants, dye transfer inhibitors, encapsulated perfume, polycarboxylates, structurant, pH trimming agents, antioxidants, preservatives, antibacterial agents including Tinosan HP100, probiotics, and mixtures thereof. In some examples, the laundry detergent composition has a pH between 6 and 10, between 6.5 and 8.9, or between 7 and 8, wherein the pH of the laundry detergent composition is measured as a 10% product concentration in demineralized water at 20° C. When liquid, the laundry detergent composition may be Newtonian or non-Newtonian. In some examples, the liquid laundry detergent composition is non-Newtonian. Without wishing to be bound by theory, a non-Newtonian liquid has properties that differ from those of a Newtonian liquid, more specifically, the viscosity of non-Newtonian liquids is dependent on shear rate, while a Newtonian liquid has a constant viscosity independent of the applied shear rate. The decreased viscosity upon shear application for non-Newtonian liquids is thought to further facilitate liquid detergent dissolution. The liquid laundry detergent composition described herein can have any suitable viscosity depending on factors such as formulated ingredients and purpose of the composition.

### COMBINATIONS

Various embodiments relate to:

1. A liquid detergent composition comprising:
at least one component, according to any one or more of Formulas 7-12:

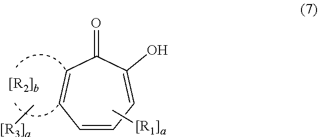

wherein:
R₁ is hydroxyl, C₁-C₆ carboxyl, a linear or branched C₁-C₆ alkyl; a linear or branched C₂-C₆ alkenyl; or a linear or branched C₂-C₆ alkynyl group;
a is from 0 to 5;
R₂ is a fused C₁-C₆ cycloalkyl, a fused C₁-C₆ cycloalkoxy, or a fused C₁-C₆ cycloalkenyl;
b is from 0 to 4;
R₃ is oxygen or hydroxyl; and
c is from 0 to 4,
and combinations and salts thereof;

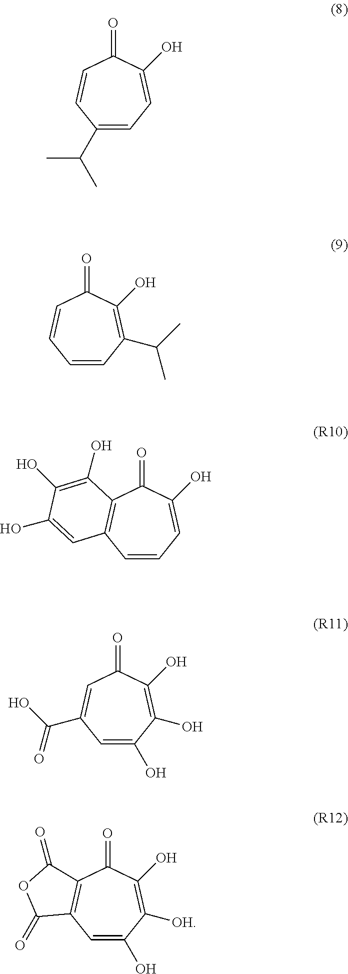 [SMILES: CC(C)c1ccc(O)c(=O)cc1 ; CC(C)c1ccccc(=O)c1O ; O=c1c(O)cccc2cc(O)c(O)c(O)c12 ; O=C(O)c1cc(O)c(O)c(O)c(=O)c1 ; O=C1OC(=O)c2c1cc(O)c(O)c(O)c2=O]

2. The liquid detergent composition according to 1, wherein the at least one component according to Formula 7 is tropolone or a salt thereof.

3. The liquid detergent composition according to any of 1 or 2, wherein the at least one component according to Formula 7 is hinokitiol or a salt thereof.

4. The liquid detergent composition according to any of 1-3, wherein the at least one component has a pKa of about 8, preferably about 8 or less, more preferably about 7.5 or less, even more preferably from about 5 to about 8, even more preferably from about 5.0 to about 7.5, even more preferably from about 5.0 to about 7.25, or most preferably from about 5.0 to about 7.0.

5. The liquid detergent composition according to any of 1-4, wherein the at least one component has a calcium binding efficiency of less than about 7, preferably from about 2 to about 7.0, from about 2 to about 6.8, from about 2.0 to about 6.5, from about 2.0 o about 6.0, from about 2.0 to about 5.5, from about 2.0 to about 5.0, from about 2.0 to about 4.5, from about 2.0 to about 4.5, from about 2.0 to about 4.0, more preferably from about 2.5 to about 3.5, or about 2.7 to about 3.1.

6. The liquid detergent composition according to any of 1-5, wherein the at least one component has an iron binding efficiency greater than about 10, about 10 to about 20, or about 10.5 to about 14.1, or about 11 to about 12.9.

7. The liquid detergent composition according to any of 1-6, wherein the at least one component is present in an amount of from greater than about 0 to about 10% or about 0.5 to about 9.5% by weight, or about 0.5 to about 9.5% by weight, or about 1.0 to about 9.0% by weight, or about 1.5 to about 8.5% by weight, or about 2.0 to about 8.0% by weight, or about 2.5 to about 7.5% by weight, or about 3.0 to about 7.0% by weight, or about 3.5 to about 6.5% by weight, or about 4.0 to about 6.0% by weight, or about 4.5 to about 5.5% by weight, or about 4.0 to about 5.0%, by weight of the liquid detergent composition.

8. The liquid detergent composition according to any of 1-7, further comprising a surfactant comprising an anionic surfactant, a nonionic surfactant, or a combination thereof.

9. The liquid detergent composition according to 8, wherein the surfactant is an anionic surfactant comprising sodium lauryl sulfate, linear alkyl benzene sulfonic acid, branched 2-alkyl primary alkyl alcohol sulfate, alkyl sulphate, or a combination thereof; more preferably an alkylbenzene sulfonate.

10. A single unit dose detergent comprising the liquid detergent composition according to any of 1-9.

11. A method for treating a stain on a fabric, comprising:
washing the fabric in a wash liquor comprising a liquid detergent composition comprising at least one component, according to one or more of Formulas 7-12:

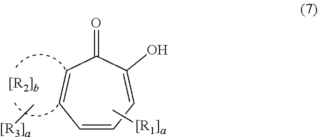

wherein:
R₁ is hydroxyl, C₁-C₆ carboxyl, a linear or branched C₁-C₆ alkyl; a linear or branched C₂-C₆ alkenyl; or a linear or branched C₂-C₆ alkynyl group;
a is from 0 to 5;
R₂ is a fused C₁-C₆ cycloalkyl, a fused C₁-C₆ cycloalkoxy, or a fused C₁-C₆ cycloalkenyl;
b is from 0 to 4;
R₃ is oxygen or hydroxyl; and
c is from 0 to 4,
and combinations and salts thereof;

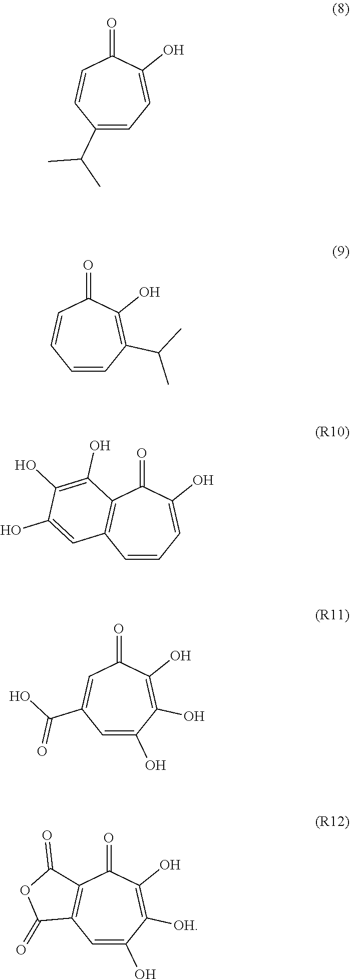 [SMILES: CC(C)c1ccc(O)c(=O)cc1 ; CC(C)c1ccccc(=O)c1O ; O=c1c(O)cccc2cc(O)c(O)c(O)c12 ; O=C(O)c1cc(O)c(O)c(O)c(=O)c1 ; O=C1OC(=O)c2c1cc(O)c(O)c(O)c2=O]

12. A method for pre-treating a strain on a fabric, comprising:
applying a liquid detergent composition to the fabric, the liquid detergent composition comprising at least one component, according to one or more of Formulas 7-12:

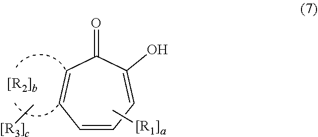

wherein:
R₁ is hydroxyl, C₁-C₆ carboxyl, a linear or branched C₁-C₆ alkyl; a linear or branched C₂-C₆ alkenyl; or a linear or branched C₂-C₆ alkynyl group;
a is from 0 to 5;
R₂ is a fused C₁-C₆ cycloalkyl, a fused C₁-C₆ cycloalkoxy, or a fused C₁-C₆ cycloalkenyl;
b is from 0 to 4;
R₃ is oxygen or hydroxyl; and
c is from 0 to 4, and combinations and salts thereof;

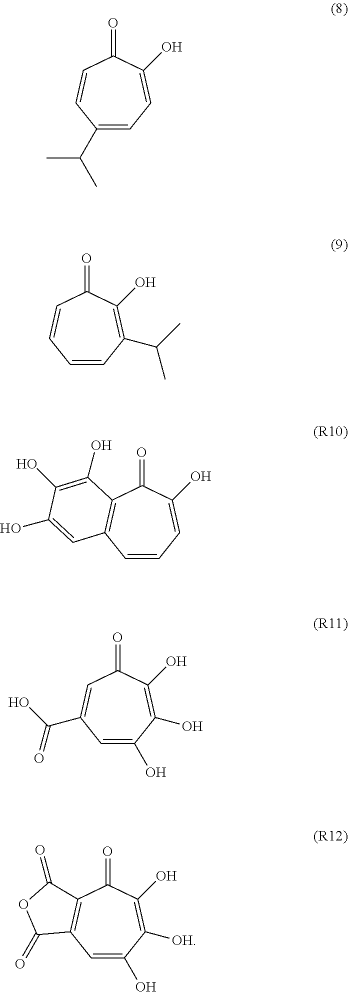 [SMILES: CC(C)c1ccc(O)c(=O)cc1 ; CC(C)c1ccccc(=O)c1O ; O=c1c(O)cccc2cc(O)c(O)c(O)c12 ; O=C(O)c1cc(O)c(O)c(O)c(=O)c1 ; O=C1OC(=O)c2c1cc(O)c(O)c(O)c2=O]

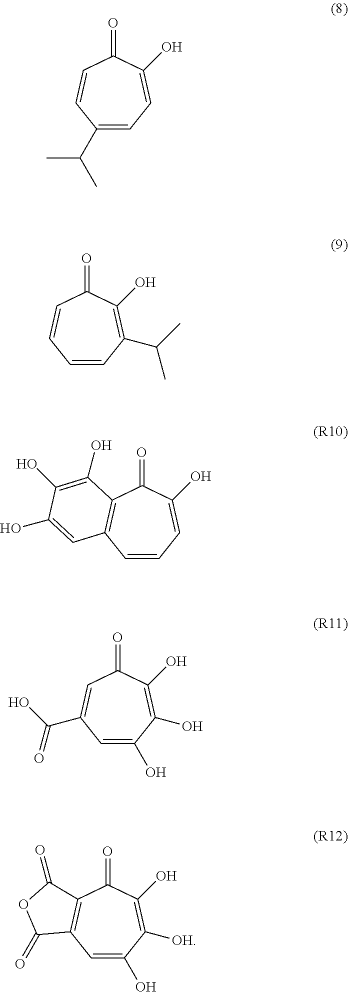 [SMILES: CC(C)c1ccc(O)c(=O)cc1 ; CC(C)c1ccccc(=O)c1O ; O=c1c(O)cccc2cc(O)c(O)c(O)c12 ; O=C(O)c1cc(O)c(O)c(O)c(=O)c1 ; O=C1OC(=O)c2c1cc(O)c(O)c(O)c2=O]

13. The method according to any of 11-12, wherein the at least one component according to Formula 7 is tropolone or a salt thereof.

14. The method according to any of 11-13, wherein the at least one component according to Formula 7 is hinokitiol or a salt thereof.

15. The method according to any of 11-14, wherein the at least one component has a pKa of about 8, preferably about 8 or less, more preferably about 7.5 or less, even more preferably from about 5 to about 8, even more preferably from about 5.0 to about 7.5, even more preferably from about 5.0 to about 7.25, or most preferably from about 5.0 to about 7.0.

16. The method according to any of 11-15, wherein the at least one component has a calcium binding efficiency of less than about 7, preferably from about 2 to about 7.0, from about 2 to about 6.8, from about 2.0 to about 6.5, from about 2.0 o about 6.0, from about 2.0 to about 5.5, from about 2.0 to about 5.0, from about 2.0 to about 4.5, from about 2.0 to about 4.5, from about 2.0 to about 4.0, more preferably from about 2.5 to about 3.5, or about 2.7 to about 3.1.

17. The method according to any of 11-16, wherein the at least one component has an iron binding efficiency greater than about 10, about 10 to about 20, or about 10.5 to about 14.1, or about 11 to about 12.9.

18. The method according to any of 11-17, wherein the at least one component is present in an amount of from greater than about 0 to about 10% or about 0.5 to about 9.5% by weight, or about 0.5 to about 9.5% by weight, or about 1.0 to about 9.0% by weight, or about 1.5 to about 8.5% by weight, or about 2.0 to about 8.0% by weight, or about 2.5 to about 7.5% by weight, or about 3.0 to about 7.0% by weight, or about 3.5 to about 6.5% by weight, or about 4.0 to about 6.0% by weight, or about 4.5 to about 5.5% by weight, or about 4.0 to about 5.0%, by weight of the liquid detergent composition.

19. The method according to any of 11-18, further comprising maintaining the pH of the wash liquor at less than about 10, from about 7 to about 9.9, from about 7.5 to about 9.0, from about 7.5 to about 8.75, from about 8.0 to about 9.0.

20. The method according to any of 11-19, wherein the liquid detergent composition is delivered to the wash liquor via a single unit dose detergent comprising the liquid detergent composition.

21. The method according to any of 11-20, wherein the liquid detergent composition further comprises a surfactant comprising an anionic surfactant, a nonionic surfactant, or a combination thereof, preferably an anionic surfactant comprising an alkylbenezene sulfonate, methyl ester sulfonate, alkyl ether carboxylate, alkyl sulfate, alkylalkoxylated sulfate, or a combination thereof; more preferably an alkylbenzene sulfonate.

22. Use of a liquid detergent composition comprising at least one component of Formulas 7-12, to treat a stain on and/or clean a fabric,

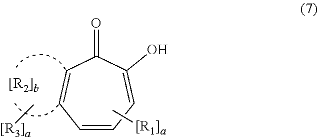

wherein:
R₁ is hydroxyl, C₁-C₆ carboxyl, a linear or branched C₁-C₆ alkyl; a linear or branched C₂-C₆ alkenyl; or a linear or branched C₂-C₆ alkynyl group;
a is from 0 to 5;
R₂ is a fused C₁-C₆ cycloalkyl, a fused C₁-C₆ cycloalkoxy, or a fused C₁-C₆ cycloalkenyl;
b is from 0 to 4;
R₃ is oxygen or hydroxyl; and
c is from 0 to 4, and combinations and salts thereof;

23. The use according to 22, wherein the at least one component according to Formula 7 is tropolone or a salt thereof.

24. The use according to any of 22-23, wherein the at least one component according to Formula 7 is hinokitiol or a salt thereof.

25. The use according to any of 22-24, wherein the at least one component has a pKa of about 8, preferably about 8 or less, more preferably about 7.5 or less, even more preferably from about 5 to about 8, even more preferably from about 5.0 to about 7.5, even more preferably from about 5.0 to about 7.25, or most preferably from about 5.0 to about 7.0.

26. The use according to any of 22-25, wherein the at least one component has a calcium binding efficiency of less than about 7, preferably from about 2 to about 7.0, from about 2 to about 6.8, from about 2.0 to about 6.5, from about 2.0 o about 6.0, from about 2.0 to about 5.5, from about 2.0 to about 5.0, from about 2.0 to about 4.5, from about 2.0 to about 4.5, from about 2.0 to about 4.0, more preferably from about 2.5 to about 3.5, or about 2.7 to about 3.1.

27. The use according to any of 22-26, wherein the at least one component has an iron binding efficiency greater than about 10, about 10 to about 20, or about 10.5 to about 14.1, or about 11 to about 12.9.

28. The use according to any of 22-27, wherein the at least one component is present in an amount of from greater than about 0 to about 10% or about 0.5 to about 9.5% by weight, or about 0.5 to about 9.5% by weight, or about 1.0 to about 9.0% by weight, or about 1.5 to about 8.5% by weight, or about 2.0 to about 8.0% by weight, or about 2.5 to about 7.5% by weight, or about 3.0 to about 7.0% by weight, or about 3.5 to about 6.5% by weight, or about 4.0 to about 6.0% by weight, or about 4.5 to about 5.5% by weight, or about 4.0 to about 5.0%, by weight of the liquid detergent composition.

29. The use according to any of 22-28, wherein the liquid detergent composition further comprises a surfactant selected from the group consisting of an anionic surfactant, a nonionic surfactant, and combinations thereof.

30. The use according to 29, wherein the surfactant is an anionic surfactant comprising least one selected from the group consisting of sodium lauryl sulfate, linear alkyl benzene sulfonic acid, branched 2-alkyl primary alkyl alcohol sulfate, alkyl sulphate, or a combination thereof, preferably an alkylbenzene sulfonate.

31. The use according to any of 22-30, wherein the liquid detergent composition is contained within a single unit dose.

### Examples

The following examples are put forth to provide those of ordinary skill in the art with a complete disclosure and description of how to perform the methods, how to make, and how to use the compositions and compounds disclosed and claimed herein. Efforts have been made to ensure accuracy with respect to numbers (e.g., amounts, temperature, etc.), but some errors and deviations should be accounted for. The purpose of the following examples is not to limit the scope of the various embodiments, but merely to provide examples illustrating specific embodiments.

### Stain Removal Index Calculation Method

Image analysis may be used to compare each stain to an unstained fabric control. Software may be used to convert images taken into standard colorimetric values and to compare these to standards based on the commonly used Macbeth Color Rendition Chart, assigning each stain a colorimetric value (Stain Level). The CIELAB color space, also referred to as L*a*b*, is a color space defined by the International Commission on Illumination (abbreviated CIE) in 1976.[a] It expresses color as three values: L* for perceptual lightness and a* and b* for the four unique colors of human vision: red, green, blue and yellow. The lightness value, L* defines black at 0 and white at 100. The a* axis is relative to the green-magenta opponent colors, with negative values toward green and positive values toward magenta. The b* axis represents the blue-yellow opponents, with negative numbers toward blue and positive toward yellow. In the following examples, various fabrics were analyzed using commercially available image analysis software for L*a*b* values. SRI values were then calculated from the L*a*b* values using the formula shown. The higher the SRI, the better the stain removal.

$$\% Stain Removal Index ( S R I ) = \frac{Δ Eb - Δ Ea}{Δ Eb} \times 100 \\ in which , \\ Δ {E}_{b} = √ ( {( {L}_{c} - {L}_{b} b )}^{2} + {( {a}_{c} - {a}_{b} )}^{2} + {( {b}_{c} - {b}_{b} )}^{2} ) \\ Δ {E}_{a} = √ ( {( {L}_{c} - {L}_{a} )}^{2} + {( {a}_{c} - {a}_{a} )}^{2} + {( {b}_{c} - {b}_{a} )}^{2} )$$

Subscript ‘b’ denotes data for the stain before washing
Subscript ‘a’ denotes data for the stain after washing
Subscript ‘c’ denotes data for the unstained fabric
   Thus, L*a*b* values are taken of the unstained fabric, of the stained fabric before washing and of the stained fabric after washing.

### Example 1: Single Unit Doses

Four detergent compositions, suitable for a unit dose detergent were made and tested as detailed herein below. The composition for each is provided below. Table 2A provides amounts in ppm of the given component active in the wash solution. Table 2B provides amounts by weight % in the composition.

TABLE 2A

| | ppm Active in wash solution | | | |
|---|---|---|---|---|
| | for Composition | | | |
| Component | C1-1 | C1-2 | C1-3 | C1-4 |
| Deionised Water | 51.944 | 51.944 | 51.944 | 51.944 |
| Citric Acid | 10.872 | 10.872 | 10.872 | 10.872 |
| 1,2 Propylene Glycol | 182.852 | 182.852 | 182.852 | 182.852 |
| Monoethanolamine | 89.481 | 89.481 | 89.481 | 89.481 |
| Glycerine | 74.206 | 74.206 | 74.206 | 74.206 |
| Sodium 1-hy- | 0.000 | 34.801 | 0.000 | 0.000 |
| droxyethyidene-1,1- | | | | |
| diphosphonate (HEDP) | | | | |
| Tropolone | 0.000 | 0.000 | 34.801 | 0.000 |
| Hinokitiol | 0.000 | 0.000 | 0.000 | 34.801 |
| Potassium Sulfite | 6.186 | 6.186 | 6.186 | 6.186 |
| C12-14 Alcohol | 53.832 | 53.832 | 53.832 | 53.832 |
| Ethoxylate AE7 | | | | |
| HLAS | 382.501 | 382.501 | 382.501 | 382.501 |
| Disodium 4,4′-Bis- | 4.756 | 4.756 | 4.756 | 4.756 |
| (2-Sulfostyryl)Biphenyl | | | | |
| C12-C18 Fatty Acid | 25.088 | 25.088 | 25.088 | 25.088 |
| Alkyl Ethoxy Sulfate | 196.905 | 196.905 | 196.905 | 196.905 |
| C24E3S | | | | |
| Cleaning Polymer 1 | 28.995 | 28.995 | 28.995 | 28.995 |
| Cleaning polymer 2 | 24.647 | 24.647 | 24.647 | 24.647 |
| Magnesium Chloride | 4.982 | 4.982 | 4.982 | 4.982 |
| Sokalan PG101(PEG Vac | 39.858 | 39.858 | 39.858 | 39.858 |
| Polymer supplied by | | | | |
| BASF | | | | |
| antifoam | 4.680 | 4.680 | 4.680 | 4.680 |
| Protease | 1.022 | 1.022 | 1.022 | 1.022 |
| Amylase 1 | 0.147 | 0.147 | 0.147 | 0.147 |
| Amylase 2 | 0.037 | 0.037 | 0.037 | 0.037 |
| Mannanase | 0.058 | 0.058 | 0.058 | 0.058 |
| Phosphodiesterase | 0.184 | 0.184 | 0.184 | 0.184 |
| Hydrogenated Castor Oil | 1.404 | 1.404 | 1.404 | 1.404 |
| Processing Aids, Minors, | 380.563 | 380.563 | 380.563 | 380.563 |
| Aesthetic Dyes and | | | | |
| Perfume | | | | |
| Total ppm | 1565 | 1600 | 1600 | 1600 |

TABLE 2B

| | % Active in Composition | | | |
|---|---|---|---|---|
| Component | C1-1 | C1-2 | C1-3 | C1-4 |
| Deionised Water | 3.3187 | 3.2465 | 3.2465 | 3.2465 |
| Citric Acid | 0.6946 | 0.6795 | 0.6795 | 0.6795 |
| 1,2 Propylene Glycol | 12.066 | 11.804 | 11.804 | 11.804 |
| Monoethanolamine | 5.333 | 5.217 | 5.217 | 5.217 |
| Glycerine | 4.7410 | 4.6379 | 4.6379 | 4.6379 |
| Sodium 1-hy- | 0.0000 | 2.1751 | 0.0000 | 0.0000 |
| droxyethyidene- | | | | |
| 1,1-diphosphonate | | | | |
| (HEDP) | | | | |
| Tropolone | 0.0000 | 0.0000 | 2.1751 | 0.0000 |
| Hinokitiol | 0.0000 | 0.0000 | 0.0000 | 2.1751 |
| Potassium Sulfite | 0.3952 | 0.3866 | 0.3866 | 0.3866 |
| C12-14 Alcohol | 3.4393 | 3.3645 | 3.3645 | 3.3645 |
| Ethoxylate AE7 | | | | |
| HLAS | 24.4378 | 23.9063 | 23.9063 | 23.9063 |
| Disodium 4,4′-Bis-(2- | 0.3039 | 0.2973 | 0.2973 | 0.2973 |
| Sulfostyryl)Biphenyl | | | | |
| C12-C18 Fatty Acid | 1.6029 | 1.5680 | 1.5680 | 1.5680 |
| Alkyl Ethoxy Sulfate | 12.5802 | 12.3066 | 12.3066 | 12.3066 |
| C24E3S | | | | |
| Cleaning polymer 1 | 1.8525 | 1.8122 | 1.8122 | 1.8122 |
| Cleaning polymer 2 | 1.5747 | 1.5404 | 1.5404 | 1.5404 |
| Magnesium Chloride | 0.3183 | 0.3114 | 0.3114 | 0.3114 |
| Sokalan PG101(PEG Vac | 2.5465 | 2.4911 | 2.4911 | 2.4911 |
| Polymer supplied by | | | | |
| BASF | | | | |
| AF8017 Antifoam | 0.2990 | 0.2925 | 0.2925 | 0.2925 |
| (Silicone Antifoam | | | | |
| Supplied by Dow) | | | | |
| Protease | 0.0653 | 0.0639 | 0.0639 | 0.0639 |
| Amylase 1 | 0.0094 | 0.0092 | 0.0092 | 0.0092 |
| Amylase 2 | 0.0024 | 0.0023 | 0.0023 | 0.0023 |
| Mannanase | 0.0037 | 0.0036 | 0.0036 | 0.0036 |
| Phosphodiesterase | 0.0118 | 0.0115 | 0.0115 | 0.0115 |
| Hydrogenated Castor Oil | 0.0897 | 0.0878 | 0.0878 | 0.0878 |
| Processing Aids, Minors, | 24.3140 | 23.7852 | 23.7852 | 23.7852 |
| Aesthetic Dyes and | | | | |
| Perfume | | | | |
| Total Wt. % | 100.000 | 100.000 | 100.000 | 100.000 |

The following method was used to test the ability of the compositions to remove stains in a wash process. Each of the compositions were added separately into pots of a tergotometer.

The volume of each pot was 1 L. The wash temperature was set to 35° C. Throughout the procedure, 21 gpg water was used. The products were agitated for 1 minute (400 rpm) before addition of fabrics (two internal replicates of each stain, 13×6 cm² SBL2004 (supplied by WFK) and additional 6 cm² knitted cotton ballast squares to make the total fabric weight up to 60 g). Once the fabrics were added, the wash solution was agitated for 30 minutes (300 rpm). The wash solutions were then drained, and the fabrics were twice subjected to a 5-minute rinse step before being drained and spun dry. This procedure was repeated a further three times to give a total of four external replicates. After the wash, the stain fabrics were dried for 30 minutes in a tumble dryer.

One dose of detergent treatment, as detailed in Table 3 below, was added to a tergotometer and was evaluated using the Washing Method.

TABLE 3

| | | Final |
|---|---|---|
| | | Composition |
| Treatment | Treatment Composition | pH |
| 1A | 1.565 g Composition C1-1 + 0.5 ml 1M HCl | 7.0 |
| 1B | 1.600 g Composition C1-2 + 0.2 ml 1M NaOH | 7.0 |
| 1C | 1.600 g Composition C1-3 + 0.5 ml 1M HCl | 7.0 |
| 1D | 1.565 g Composition C1-1 + 0.7 ml 1M NaOH | 8.5 |
| 1E | 1.600 g Composition C1-2 + 1.0 ml 1M NaOH | 8.5 |
| 1F | 1.600 g Composition C1-3 + 0.7 ml 1M NaOH | 8.5 |
| 1G | 1.565 g Composition C1-1 + 3.5 ml 1M NaOH | 10.0 |
| 1H | 1.600 g Composition C1-2 + 4.0 ml 1M NaOH | 10.0 |
| 1I | 1.600 g Composition C1-3 + 3.5 ml 1M NaOH | 10.0 |
| 1J | 1.600 g Composition C1-4 + 0.5 ml 1M HCl | 7.0 |
| 1K | 1.600 g Composition C1-4 + 0.7 ml 1M NaOH | 8.5 |
| 1L | 1.600 g Composition C1-4 + 3.5 ml 1M NaOH | 10.0 |

Table 4 summarizes stain removal testing of HEDP versus tropolone.

TABLE 4

| | SRI for Treatment | | | | | | | | | |
|---|---|---|---|---|---|---|---|---|---|---|
| Stain | 1A | 1B | 1C | 1D | 1E | 1F | 1G | 1H | 1I | HSD |
| Tea | 27.8 | 43 A | 50.5 A | 24.3 | 29.6 | 35.3 D | 12.4 | 10.6 | 10.3 | 7.79 |
| American | | | | | | | | | | |
| Lipton | | | | | | | | | | |

Note:
Upper Case letters indicate significant difference between treatments at alpha = 0.05 using Tukey's honestly significant difference (HSD). The capital letter which the treatment has next to its SRI score shows versus which treatment it has superior performance. For example, where 1C has a capital A next to its SRI score, it means 1C is significantly better than 1A.

As may be seen from Table 4, treatments with pH<10.0 delivered improved stain removal performance in the presence of tropolone compared to HEDP or no chelating agent.

Table 5 summarizes stain removal testing of HEDP versus hinokitiol.

TABLE 5

| | SRI for Treatment | | | | | | | | | |
|---|---|---|---|---|---|---|---|---|---|---|
| Stain | 1A | 1B | 1J | 1D | 1E | 1K | 1G | 1H | 1L | HSD |
| Tea | 26.1 | 40 A | 48.3 A | 24.7 | 29.7 | 36.9 D | 7 | 8.1 | 7.1 | 5.77 |
| American | | | | | | | | | | |
| Lipton | | | | | | | | | | |

Note:
Upper Case letters indicate significant difference between treatments at alpha = 0.05 using Tukey's honestly significant difference (HSD).

As may be seen from Table 5, Examples with pH<10.0 deliver improved stain removal performance in the presence of Hinokitiol.

### Example 2: Stain Pretreatment

Four liquid detergent compositions were made and tested as detailed herein below. The composition for each is provided below. Table 6A provides amounts in ppm of the given component active in the wash solution. Table 6B provides amounts by weight % in the composition.

TABLE 6A

| | ppm Active in wash solution | | | |
|---|---|---|---|---|
| | for Composition | | | |
| Component | C2-1 | C2-2 | C2-3 | C2-4 |
| Deionised Water | 3975.468 | 3975.468 | 3975.468 | 3975.468 |
| Caustic Soda (Liquid) | 268.880 | 268.880 | 268.880 | 268.880 |
| 50% NaOH | | | | |
| Citric Acid | 226.050 | 226.050 | 226.050 | 226.050 |
| Sodium Cumene | 57.368 | 57.368 | 57.368 | 57.368 |
| Sulphonate | | | | |
| HLAS | 748.640 | 748.640 | 748.640 | 748.640 |
| C12-14 Alcohol | 637.256 | 637.256 | 637.256 | 637.256 |
| Ethoxylate AE7 | | | | |
| Calcium Chloride | 0.976 | 0.976 | 0.976 | 0.976 |
| Diethylenetriamine | 0.000 | 35.910 | 0.000 | 0.000 |
| penta(methylene | | | | |
| phosphonic acid) | | | | |
| (DTPMP) | | | | |
| Hinokitiol | 0.000 | 0.000 | 35.910 | 0.000 |
| Tropolone | 0.000 | 0.000 | 0.000 | 35.910 |
| C12-C18 Fatty Acid | 182.314 | 182.314 | 182.314 | 182.314 |
| Lutensit Z 96 (supplied | 43.816 | 43.816 | 43.816 | 43.816 |
| by BASF) | | | | |
| Alkyl Ethoxy Sulfate | 187.176 | 187.176 | 187.176 | 187.176 |
| C24E3S | | | | |
| 1,2-Benzisothiazolin- | 0.704 | 0.704 | 0.704 | 0.704 |
| 3-ONE | | | | |
| Protease | 2.552 | 2.552 | 2.552 | 2.552 |
| 1,2 Propylene Glycol | 59.972 | 59.972 | 59.972 | 59.972 |
| Disodium 4,4′-Bis-(2- | 3.678 | 3.678 | 3.678 | 3.678 |
| Sulfostyryl)Biphenyl | | | | |
| Solvite 88YPG | 1.054 | 1.054 | 1.054 | 1.054 |
| XIAMETER AFE-0110 | 0.200 | 0.200 | 0.200 | 0.200 |
| Antifoam (Silicone | | | | |
| Antifoam supplied | | | | |
| by Dow) | | | | |
| Amylase | 0.270 | 0.270 | 0.270 | 0.270 |
| Mannanase | 0.140 | 0.140 | 0.140 | 0.140 |
| Pectate Lyase | 0.112 | 0.112 | 0.112 | 0.112 |
| Phosphodiesterase | 0.358 | 0.358 | 0.358 | 0.358 |
| Sokalan PG101(PEG Vac | 61.320 | 61.320 | 61.320 | 61.320 |
| Polymer supplied by | | | | |
| BASF | | | | |
| Hydrogenated Castor Oil | 20.092 | 20.092 | 20.092 | 20.092 |
| Processing Aids, Minors, | 1521.604 | 1521.604 | 1521.604 | 1521.604 |
| Aesthetic Dyes and | | | | |
| Perfumes | | | | |
| Total ppm | 8000.000 | 8035.910 | 8035.910 | 8035.910 |

TABLE 6B

| | % Active in Composition | | | |
|---|---|---|---|---|
| Component | C2-1 | C2-2 | C2-3 | C2-4 |
| Deionised Water | 49.6934 | 49.4713 | 49.4713 | 49.4713 |
| Caustic Soda (Liquid) | 3.3610 | 3.3460 | 3.3460 | 3.3460 |
| 50% NaOH | | | | |
| Citric Acid | 2.8256 | 2.8130 | 2.8130 | 2.8130 |
| Sodium Cumene | 0.7171 | 0.7139 | 0.7139 | 0.7139 |
| Sulphonate | | | | |
| HLAS | 9.3580 | 9.3162 | 9.3162 | 9.3162 |
| C12-14 Alcohol | 7.9657 | 7.9301 | 7.9301 | 7.9301 |
| Ethoxylate AE7 | | | | |
| Calcium Chloride | 0.0122 | 0.0121 | 0.0121 | 0.0121 |
| Diethylenetriamine | 0.0000 | 0.4469 | 0.0000 | 0.0000 |
| penta(methylene | | | | |
| phosphonic acid) | | | | |
| (DTPMP) | | | | |
| Hinokitiol | 0.0000 | 0.0000 | 0.4469 | 0.0000 |
| Tropolone | 0.0000 | 0.0000 | 0.0000 | 0.4469 |
| C12-C18 Fatty Acid | 2.2789 | 2.2687 | 2.2687 | 2.2687 |
| Lutensit Z 96 (supplied | 0.5477 | 0.5453 | 0.5453 | 0.5453 |
| by BASF) | | | | |
| Alkyl Ethoxy Sulfate | 2.3397 | 2.3292 | 2.3292 | 2.3292 |
| C24E3S | | | | |
| 1,2-Benzisothiazolin- | 0.0088 | 0.0088 | 0.0088 | 0.0088 |
| 3-ONE | | | | |
| Protease | 0.0319 | 0.0318 | 0.0318 | 0.0318 |
| 1,2 Propylene Glycol | 0.7497 | 0.7463 | 0.7463 | 0.7463 |
| Disodium 4,4′-Bis-(2- | 0.0460 | 0.0458 | 0.0458 | 0.0458 |
| Sulfostyryl)Biphenyl | | | | |
| XIAMETER AFE-0110 | 0.0025 | 0.0025 | 0.0025 | 0.0025 |
| Antifoam | | | | |
| (Silicone Antifoam | | | | |
| supplied by Dow) | | | | |
| Amylase | 0.0034 | 0.0034 | 0.0034 | 0.0034 |
| Mannanase | 0.0018 | 0.0017 | 0.0017 | 0.0017 |
| Pectate Lyase | 0.0014 | 0.0014 | 0.0014 | 0.0014 |
| Phosphodiesterase | 0.0045 | 0.0045 | 0.0045 | 0.0045 |
| Sokalan PG101(PEG Vac | 0.7665 | 0.7631 | 0.7631 | 0.7631 |
| Polymer supplied by | | | | |
| BASF | | | | |
| Hydrogenated Castor Oil | 0.2512 | 0.2500 | 0.2500 | 0.2500 |
| Processing Aids, Minors, | 19.0332 | 18.9482 | 18.9482 | 18.9482 |
| Aesthetic Dyes and | | | | |
| Perfumes | | | | |
| Total Wt. % | 100.0000 | 100.0000 | 100.0000 | 100.0000 |

The following method was used to test the ability of the example compositions to remove stains following treatment prior to the wash process. With reference to Table 7, full detergent additions for Treatments 2A-2D were added separately into pots of a tergotometer. For Treatments 2E-2H, the pretreatment dosage of each detergent composition was applied equally across 4 stained fabrics via syringe. Following application, the end of the syringe was used to apply pressure to each stain in a circular motion for 5 seconds. Pretreated stains were then allowed to sit for 10 minutes before being added into pots of a tergotometer along with the remaining treatment detergent. The volume of each pot was 1 L. The wash temperature was set to 35° C. Throughout the procedure, 21 gpg water was used. The products were agitated for 1 minute (400 rpm) before addition of fabrics (two internal replicates of each stain, 13×6 cm² SBL2004 (supplied by WFK) and additional 6 cm² knitted cotton ballast squares to make the total fabric weight up to 60 g). Once the fabrics were added, the wash solution was agitated for 30 minutes (300 rpm). The wash solutions were then drained and the fabrics were twice subjected to a 5 minute rinse step before being drained and spun dry. This procedure was repeated a further three times to give a total of four external replicates. After the wash, the stain fabrics were dried for 30 minutes in a tumble dryer.

TABLE 7

| Treatment | Treatment Composition |
|---|---|
| 2A | 8.000 g Composition C2-1 |
| 2B | 8.036 g Composition C2-2 |
| 2C | 8.036 g Composition C2-3 |
| 2D | 8.036 g Composition C2-4 |
| 2E | 8.000 g Composition C2-1 (1.6000 g of which delivered |
| | by stain pretreatment) |
| 2F | 8.036 g Composition C2-2 (1.6072 g of which delivered |
| | by stain pretreatment) |
| 2G | 8.036 g Composition C2-3 (1.6072 g of which delivered |
| | by stain pretreatment) |
| 2H | 8.036 g Composition C2-4 (1.6072 g of which delivered |
| | by stain pretreatment) |

Table 8 summarizes stain removal testing for each treatment.

TABLE 8

| | Tea | | | Lipton Tea | | |
|---|---|---|---|---|---|---|
| | | | Delta | | | Delta |
| | | | vs nil | | | vs nil |
| Treatment | SRI | | pretreat | SRI | | pretreat |
| 2A | 17.0 | | | 26.1 | | |
| 2B | 25.3 | A | | 34.1 | A | |
| 2C | 27.7 | A | | 34.9 | A | |
| 2D | 33.3 | AB | | 41.5 | ABCE | |
| 2E | 21.9 | | 4.9 | 31.2 | A | 5.1 |
| 2F | 38.5 | ABCE | 13.2 | 45.6 | ABCE | 11.5 |
| 2G | 57.9 | ABCDEF | 30.2 | 57.2 | ABCDEF | 22.3 |
| 2H | 62.4 | ABCDEF | 29.1 | 59.5 | ABCDEF | 18 |

| | | |
|---|---|---|
| Tukey's HSD | 6.36 | 4.67 |

UPPER CASE letters indicate significant difference between treatments at alpha = 0.05 using Tukey's HSD.

As may be seen from Table 8, treatment compositions containing tropolone or hinokitiol, drive significantly improved stain removal with pretreatment (Treatments 2G and 2H) when compared to DTPMP with pretreatment (Treatment 2F).

### Example 3: Composition For Improved Stain Removal On Synthetic Garments

Four unit dose detergent compositions were made and tested as detailed herein below. The composition for each is provided below. Table 9A provides amounts in ppm of the given component active in the wash solution. Table 9B provides amounts by weight % in the composition.

TABLE 9A

| | ppm Active in wash solution for | | | |
|---|---|---|---|---|
| | Composition | | | |
| Component | C3-1 | C3-2 | C3-3 | C3-4 |
| Deionised Water | 51.944 | 51.944 | 51.944 | 51.944 |
| Citric Acid | 10.872 | 10.872 | 10.872 | 10.872 |
| 1,2 Propylene Glycol | 182.852 | 182.852 | 182.852 | 182.852 |
| Monoethanolamine | 89.481 | 89.481 | 89.481 | 89.481 |
| Glycerine | 74.206 | 74.206 | 74.206 | 74.206 |
| Sodium 1-hy- | 0.000 | 34.801 | 0.000 | 0.000 |
| droxyethyidene-1,1- | | | | |
| diphosphonate (HEDP) | | | | |
| Tropolone | 0.000 | 0.000 | 34.801 | 0.000 |
| Hinokitiol | 0.000 | 0.000 | 0.000 | 34.801 |
| Potassium Sulfite | 6.186 | 6.186 | 6.186 | 6.186 |
| C12-14 Alcohol | 53.832 | 53.832 | 53.832 | 53.832 |
| Ethoxylate AE7 | | | | |
| HLAS | 382.501 | 382.501 | 382.501 | 382.501 |
| Disodium 4,4′-Bis-(2- | 4.756 | 4.756 | 4.756 | 4.756 |
| Sulfostyryl)Biphenyl | | | | |
| C12-C18 Fatty Acid | 25.088 | 25.088 | 25.088 | 25.088 |
| Alkyl Ethoxy Sulfate | 196.905 | 196.905 | 196.905 | 196.905 |
| C24E3S | | | | |
| Lutensit Z 96 (Trans- | 28.995 | 28.995 | 28.995 | 28.995 |
| sulfonated Polymer | | | | |
| supplied by BASF) | | | | |
| Sokalan HP20 (Modified | 24.647 | 24.647 | 24.647 | 24.647 |
| Polyethylene Imine | | | | |
| supplied by BASF) | | | | |
| Magnesium Chloride | 4.982 | 4.982 | 4.982 | 4.982 |
| Sokalan PG101(PEG Vac | 39.858 | 39.858 | 39.858 | 39.858 |
| Polymer supplied by | | | | |
| BASF | | | | |
| AF8017 Antifoam | 4.680 | 4.680 | 4.680 | 4.680 |
| (SiliconeAntifoam | | | | |
| Supplied by Dow) | | | | |
| Protease | 1.022 | 1.022 | 1.022 | 1.022 |
| Amylase 1 | 0.147 | 0.147 | 0.147 | 0.147 |
| Amylase 2 | 0.037 | 0.037 | 0.037 | 0.037 |
| Mannanase | 0.058 | 0.058 | 0.058 | 0.058 |
| Phosphodiesterase | 0.184 | 0.184 | 0.184 | 0.184 |
| Hydrogenated Castor Oil | 1.404 | 1.404 | 1.404 | 1.404 |
| Processing Aids, Minors, | 380.563 | 380.563 | 380.563 | 380.563 |
| Aesthetic Dyes and | | | | |
| Perfume | | | | |
| Total ppm | 1565 | 1600 | 1600 | 1600 |

TABLE 9B

| | % Active in Composition | | | |
|---|---|---|---|---|
| Component | C3-1 | C3-2 | C3-3 | C3-4 |
| Deionised Water | 3.3187 | 3.2465 | 3.2465 | 3.2465 |
| Citric Acid | 0.6946 | 0.6795 | 0.6795 | 0.6795 |
| 1,2 Propylene Glycol | 12.066 | 11.804 | 11.804 | 11.804 |
| Monoethanolamine | 5.333 | 5.217 | 5.217 | 5.217 |
| Glycerine | 4.7410 | 4.6379 | 4.6379 | 4.6379 |
| Sodium 1-hy- | 0.0000 | 2.1751 | 0.0000 | 0.0000 |
| droxyethyidene-1,1- | | | | |
| diphosphonate (HEDP) | | | | |
| Tropolone | 0.0000 | 0.0000 | 2.1751 | 0.0000 |
| Hinokitiol | 0.0000 | 0.0000 | 0.0000 | 2.1751 |
| Potassium Sulfite | 0.3952 | 0.3866 | 0.3866 | 0.3866 |
| C12-14 Alcohol | 3.4393 | 3.3645 | 3.3645 | 3.3645 |
| Ethoxylate AE7 | | | | |
| HLAS | 24.4378 | 23.9063 | 23.9063 | 23.9063 |
| Disodium 4,4′-Bis-(2- | 0.3039 | 0.2973 | 0.2973 | 0.2973 |
| Sulfostyryl)Biphenyl | | | | |
| C12-C18 Fatty Acid | 1.6029 | 1.5680 | 1.5680 | 1.5680 |
| Alkyl Ethoxy Sulfate | 12.5802 | 12.3066 | 12.3066 | 12.3066 |
| C24E3S | | | | |
| Lutensit Z 96 (Trans- | 1.8525 | 1.8122 | 1.8122 | 1.8122 |
| sulfonated Polymer | | | | |
| supplied by BASF) | | | | |
| Sokalan HP20 (Modified | 1.5747 | 1.5404 | 1.5404 | 1.5404 |
| Polyethylene Imine | | | | |
| supplied by BASF) | | | | |
| Magnesium Chloride | 0.3183 | 0.3114 | 0.3114 | 0.3114 |
| Sokalan PG101(PEG Vac | 2.5465 | 2.4911 | 2.4911 | 2.4911 |
| Polymer supplied by | | | | |
| BASF | | | | |
| AF8017 Antifoam | 0.2990 | 0.2925 | 0.2925 | 0.2925 |
| (Silicone Antifoam | | | | |
| Supplied by Dow) | | | | |
| Protease | 0.0653 | 0.0639 | 0.0639 | 0.0639 |
| Amylase 1 | 0.0094 | 0.0092 | 0.0092 | 0.0092 |
| Amylase 2 | 0.0024 | 0.0023 | 0.0023 | 0.0023 |
| Mannanase | 0.0037 | 0.0036 | 0.0036 | 0.0036 |
| Phosphodiesterase | 0.0118 | 0.0115 | 0.0115 | 0.0115 |
| Hydrogenated Castor Oil | 0.0897 | 0.0878 | 0.0878 | 0.0878 |
| Processing Aids, Minors, | 24.3140 | 23.7852 | 23.7852 | 23.7852 |
| Aesthetic Dyes and | | | | |
| Perfume | | | | |
| Total Wt. % | 100.000 | 100.000 | 100.000 | 100.000 |

The following method was used to test the ability of the example treatment compositions, as detailed in Table 10 below, to remove stains during a wash process. Each of the compositions were added separately into pots of a tergotometer. The volume of each pot was 1 L. The wash temperature was set to 35° C. Throughout the procedure, 21 gpg water was used. The products were agitated for 1 minute (400 rpm) before addition of fabrics (two internal replicates of each stain, 13×6 cm² SBL2004 (supplied by WFK) and additional 6 cm² knitted cotton ballast squares to make the total fabric weight up to 60 g). Once the fabrics were added, the wash solution was agitated for 30 minutes (300 rpm). The wash solutions were then drained and the fabrics were twice subjected to a 5 minute rinse step before being drained and spun dry. This procedure was repeated a further three times to give a total of four external replicates. After the wash, the stain fabrics were dried for 30 minutes in a tumble dryer.

TABLE 10

| Treatment | Treatment Composition |
|---|---|
| 3A | 1.565 g Composition C3-1 |
| 3B | 1.600 g Composition C3-2 + 0.32 ml 1M NaOH (added |
| | to maintain consistent pH across all compositions) |
| 3C | 1.600 g Composition C3-3 |
| 3D | 1.600 g Composition C3-4 |

Table 11 summarizes stain removal testing for each treatment.

TABLE 11

| | SRI for Treatment | | | | | | |
|---|---|---|---|---|---|---|---|
| Stain | 3A | 3B | 3C | | 3D | | HSD |
| Red Wine Wolf Blas | 71.4 | 78.2 A | 85.4 | AB | 87.3 | AB | 3.30 |
| on Polyester | | | | | | | |
| Red Wine Wolf Blas | 40.8 | 47.2 A | 50.0 | A | 47.1 | A | 3.37 |
| on Knitted Cotton | | | | | | | |

Note:
UPPER CASE letters indicate significant difference between treatments at alpha = 0.05 using Tukey's HSD.

As may be seen from the above SRI Values, Formulae C & D of this invention, containing Tropolone or Hinokitiol, drive significantly improved stain removal on synthetics fabric (polyester) vs HEDP. As shown in Table 11, tropolone and hinokitiol demonstrated better performance than HEDP on synthetic fabrics.

### Examples 4 and 5

Examples 4 and 5 are exemplary water soluble unit dose formulations. The liquid detergent composition according to any of the embodiments described herein may be part of a single chamber water soluble unit dose article or can be split over multiple compartments resulting in below “averaged across compartments” full article composition.

### Example 4: Single Chamber Water Soluble Unit Dose Article

The composition detailed in Table 12 below is enclosed in a polyvinyl alcohol based water soluble film, more specifically a water soluble film comprising a blend of a polyvinylalcohol homopolymer and a carboxylated anionic polyvinylalcohol copolymer, alternatively a water soluble film comprising a carboxylated anionic polyvinylalcohol copolymer such as M8630 or M8310 ex the MonoSol company.

TABLE 12

| | Composition 1 |
|---|---|
| Ingredient | (wt %) |
| Fatty alcohol ethoxylate non-ionic surfactant, | 3.8 |
| C₁₂₋₁₄ average degree of ethoxylation of 7 | |
| Lutensol XL100 | 0.5 |
| Linear C₁₁₋₁₄ alkylbenzene sulphonate | 24.6 |
| C12-14 AE3S Ethoxylated alkyl sulphate with | 12.5 |
| an average degree of ethoxylation of 3 | |
| Citric acid | 0.7 |
| Palm Kernel Fatty acid | 5.3 |
| Nuclease enzyme* (wt % active protein) | 0.01 |
| Protease enzyme (wt % active protein) | 0.07 |
| Amylase enzyme (wt % active protein) | 0.005 |
| Xyloglucanase enzyme (wt % active protein) | 0.005 |
| Mannanase enzyme (wt % active protein) | 0.003 |
| Ethoxylated polyethyleneimine** | 1.6 |
| Amphiphilic graft copolymer*** | 2.6 |
| Zwitterionic polyamine**** | 1.8 |
| Anionic polyester terephthalate ***** | 0.6 |
| HEDP chelant | 2.2 |
| Brightener 49 | 0.4 |
| Silicone anti-foam | 0.3 |
| Hueing dye | 0.05 |
| 1,2 PropaneDiol | 12.3 |
| Glycerine | 4.7 |
| DPG (DiPropyleneGlycol) | 1.7 |
| TPG (TriPropyleneGlycol) | 0.1 |
| Sorbitol | 0.1 |
| Monoethanolamine | 10.2 |
| K2SO3 | 0.4 |
| MgCl2 | 0.3 |
| water | 10.8 |
| Hydrogenated castor oil | 0.1 |
| Perfume | 2.1 |
| Aesthetic dye & Minors | Balance to 100 |
| pH (10% product concentration in | 7.4 |
| demineralized water at 20° C.) | |

*Nuclease enzyme is as claimed in co-pending European application 19219568.3
**Lutensol FP620 ex BASF—ethoxylated polyethyleneimine (PEI600 E020)
***polyethylene glycol graft polymer comprising a polyethylene glycol backbone (Pluriol E6000) and hydrophobic vinyl acetate side chains, comprising 40% by weight of the polymer system of a polyethylene glycol backbone polymer and 60% by weight of the polymer system of the grafted vinyl acetate side chains
****Lutensit Z96 (zwitterionic polyamine ex BASF—zwitterionic hexamethylene diamine according to below formula: 100% quaternized and about 40% of the polyethoxy (E024) groups are sulfonated).

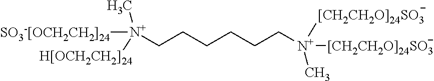

### *****Texcare SRA300 ex Clariant

### Example 5: Multi-Compartment Water Soluble Unit Dose Article

This example demonstrates a multi-compartment water soluble unit dose laundry article comprising a larger bottom compartment while having two smaller compartments in a side by side configuration superposed on top of the bottom compartment, following the Ariel 3-in-1 Pods design, as commercially available in the UK in January 2020. The compositions detailed in Table 13 are enclosed in a polyvinyl alcohol based water soluble outer film, more specifically a water soluble film comprising a blend of a polyvinylalcohol homopolymer and a carboxylated anionic polyvinylalcohol copolymer, and a water soluble middle film comprising a blend of polyvinyl alcohol homopolymers, alternatively a blend of a polyvinylalcohol homopolymer and a carboxylated anionic polyvinylalcohol copolymer.

TABLE 13

| | Full | Bottom | Top | Top |
|---|---|---|---|---|
| | arti- | compart- | compart- | compart- |
| | cle | ment | ment | ment |
| Ingredients | wt. % | | | |
| Volume | 25.5 ml | 22.3 ml | 1.6 ml | 1.6 ml |
| Fatty alcohol ethoxylate | 3.5 | 3.7 | 2.6 | 1.6 |
| non-ionic surfactant, | | | | |
| C₁₂₋₁₄ average degree | | | | |
| of ethoxylation of 7 | | | | |
| Lutensol XL100 | 0.4 | 0.5 | — | — |
| Linear C₁₁₋₁₄ alkylben- | 24.2 | 24.9 | 18.9 | 19.4 |
| zene sulphonate | | | | |
| C12-15 AE3S Ethoxylated | 12.3 | 12.6 | 9.7 | 9.7 |
| alkyl sulphate with an | | | | |
| average degree of | | | | |
| ethoxylation of 3 | | | | |
| Citric acid | 0.7 | 0.7 | 0.5 | 0.5 |
| Palm Kernel Fatty acid | 5.2 | 5.4 | 4.1 | 4.1 |
| Nuclease enzyme* (wt % | 0.009 | 0.011 | — | — |
| active protein) | | | | |
| Protease enzyme (wt % | 0.05 | 0.06 | — | — |
| active protein) | | | | |
| Amylase enzyme (wt % | 0.004 | 0.005 | — | — |
| active protein) | | | | |
| Xyloglucanase enzyme | 0.005 | — | 0.073 | — |
| (wt % active protein) | | | | |
| Mannanase enzyme (wt % | 0.003 | 0.003 | — | — |
| active protein) | | | | |
| Lipase enzyme (wt % | 0.012 | — | 0.187 | — |
| active protein) | | | | |
| Ethoxylated polyethyl- | 1.5 | 1.6 | 1.2 | 1.2 |
| eneimine** | | | | |
| Amphiphilic graft | 2.0 | 2.3 | — | — |
| copolymer*** | | | | |
| Zwitterionic | 1.8 | 1.9 | 1.4 | 1.4 |
| polyamine**** | | | | |
| Anionic polyester | 0.4 | — | — | 5.8 |
| terephthalate ***** | | | | |
| HEDP chelant | 2.2 | 2.2 | 1.7 | 1.7 |
| Brightener 49 | 0.3 | 0.4 | 0.01 | 0.01 |
| Silicone anti-foam | 0.3 | 0.3 | — | — |
| Hueing dye | 0.04 | — | 0.69 | — |
| 1,2 PropaneDiol | 13.6 | 12.8 | 11.3 | 26.4 |
| Glycerine | 6.0 | 5.0 | 17.3 | 8.3 |
| DPG (DiPropyleneGlycol) | 0.8 | 0.8 | 0.6 | 0.6 |
| TPG (TriPropyleneGlycol) | 0.06 | 0.06 | — | — |
| Sorbitol | 0.6 | 0.05 | 8.8 | — |
| Monoethanolamine | 10.0 | 10.4 | 7.9 | 8.0 |
| K2SO3 | 0.4 | 0.4 | 0.04 | 0.4 |
| MgCl2 | 0.3 | 0.3 | 0.2 | 0.2 |
| water | 10.9 | 10.9 | 11.8 | 9.9 |
| Hydrogenated castor oil | 0.1 | 0.1 | — | 0.1 |
| Perfume | 1.6 | 1.9 | — | — |
| Aesthetic dye & Minors | Balance | Balance | Balance | Balance |
| (incl. preservative) | to 100 | to 100 | to 100 | to 100 |
| pH (10% product concen- | 7.4 | 7.4 | 7.4 | 7.4 |
| tration in demineralized | | | | |
| water at 20° C.) | | | | |

*Nuclease enzyme is as claimed in co-pending European application 19219568.3
**Lutensol FP620 ex BASF—ethoxylated polyethyleneimine (PEI600 E020)
***polyethylene glycol graft polymer comprising a polyethylene glycol backbone (Pluriol E6000) and hydrophobic vinyl acetate side chains, comprising 40% by weight of the polymer system of a polyethylene glycol backbone polymer and 60% by weight of the polymer system of the grafted vinyl acetate side chains
****Lutensit Z96 (zwitterionic polyamine ex BASF—zwitterionic hexamethylene diamine according to below formula: 100% quaternized and about 40% of the polyethoxy (E024) groups are sulfonated).

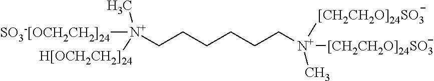

### *****Texcare SRA300 ex Clariant

### Liquid Detergent Example Formulations

| Raw | Comp. A | Comp. B | Comp. C | Comp. D | Comp. E |
|---|---|---|---|---|---|
| Material | % active in formulation | | | | |
| Alkyl Ethoxy | — | 2.11 | — | 4.23 | — |
| Sulfate ¹ | | | | | |
| Branched Alkyl | — | — | 2.11 | — | 4.23 |
| Sulfate² | | | | | |
| HLAS³ | 4.02 | 4.02 | 4.02 | 4.02 | 4.02 |
| NI⁴ | 4.96 | 4.96 | 4.96 | 4.96 | 4.96 |
| Amine oxide⁵ | 1.67 | 1.67 | 1.67 | 1.67 | 1.67 |
| Citric acid⁶ | 1.51 | 1.51 | 1.51 | 1.51 | 1.51 |
| Protease⁷ | 0.06 | 0.06 | 0.06 | 0.06 | 0.06 |
| Amylase⁸ | 0.01 | 0.01 | 0.01 | 0.01 | 0.01 |
| Borate⁹ | 1.00 | 1.00 | 1.00 | 1.00 | 1.00 |
| Ethoxylated | 2.14 | 2.14 | 2.14 | 2.14 | 2.14 |
| polyethylene- | | | | | |
| imine¹⁰ | | | | | |
| Tropolone | 2.00 | 2.00 | 2.00 | 2.00 | 2.00 |
| Misc (water, | Balance | Balance | Balance | Balance | Balance |
| solvent, etc.) | | | | | |
| Raw | Comp. F | Comp. G | Comp. 1 | Comp. 2 | Comp. 3 |
| Material | % active in formulation | | | | |
| Alkyl Ethoxy | 8.46 | — | 2.11 | 4.23 | 8.46 |
| Sulfate ¹ | | | | | |
| Branched Alkyl | — | 8.46 | 2.11 | 4.23 | 8.46 |
| Sulfate ² | | | | | |
| HLAS³ | 4.02 | 4.02 | 4.02 | 4.02 | 4.02 |
| NI⁴ | 4.96 | 4.96 | 4.96 | 4.96 | 4.96 |
| Amine oxide⁵ | 1.67 | 1.67 | 1.67 | 1.67 | 1.67 |
| Citric acid⁶ | 1.51 | 1.51 | 1.51 | 1.51 | 1.51 |
| Protease⁷ | 0.06 | 0.06 | 0.06 | 0.06 | 0.06 |
| Amylase⁸ | 0.01 | 0.01 | 0.01 | 0.01 | 0.01 |
| Borate⁹ | 1.00 | 1.00 | 1.00 | 1.00 | 1.00 |
| Ethoxylated | 2.14 | 2.14 | 2.14 | 2.14 | 2.14 |
| polyethylene- | | | | | |
| imine¹⁰ | | | | | |
| hinokitiol | 2.00 | 2.00 | 2.00 | 2.00 | 2.00 |
| Misc (water, | Balance | Balance | Balance | Balance | Balance |
| solvent, etc.) | | | | | |

| | Composition | Composition | Composition | Composition | Composition | Composition |
|---|---|---|---|---|---|---|
| | 4 | 5 | 6 | 7 | 8 | 9 |
| Raw Material | % wt | % wt | % wt | % wt | % wt | % wt |
| Branched Alkyl | 6 | 6 | 10 | 4 | 4 | 10.5 |
| Sulfate² | | | | | | |
| Sodium Lauryl | 3 | 5.3 | 3 | 0 | 0 | 0 |
| Sulfate¹¹ | | | | | | |
| HLAS³ | 5 | 12 | 8.5 | 1.5 | 12 | 1 |
| AE3S Ethoxylated | 1 | 3 | 0 | 9 | 0 | 0 |
| alkyl sulphate | | | | | | |
| with an average | | | | | | |
| degree of | | | | | | |
| ethoxylation of 3 | | | | | | |
| Alkyl ethoxy | 0 | 0 | 0 | 0 | 3.1 | 0 |
| sulfate¹ | | | | | | |
| amine oxide⁵ | 0 | 1 | 1.5 | 0.5 | 0.7 | 0 |
| C24 alkyl | 5 | 12 | 12 | 13 | 7 | 0 |
| ethoxylate (EO7) | | | | | | |
| NI⁴ | 0 | 0 | 0 | 0 | 0 | 2 |
| citric acid⁶ | 1.8 | 2 | 6.8 | 0.2 | 3.7 | 8.4 |
| palm kernel | 0 | 0.5 | 1 | 3 | 0 | 0 |
| fatty acid | | | | | | |
| topped kernel | 0 | 0.1 | 0 | 0 | 2.9 | 0 |
| fatty acid | | | | | | |
| Enzyme 1 | 0.0017 | 0 | 0.005 | 0.0017 | 0.0017 | 0.0017 |
| Enzyme 2 | 0.00342 | 0.00342 | 0.00342 | 0.00342 | 0.00342 | 0.00342 |
| Enzyme 3 | 0.00766 | 0 | 0.023 | 0.00766 | 0.00766 | 0.00766 |
| Enzyme 4 | 0.07706 | 0 | 0.07706 | 0.07706 | 0.07706 | 0.07706 |
| Enzyme 5 | 0 | 0.001 | 0.003 | 0 | 0 | 0 |
| Enzyme 6 | 0.012 | 0 | 0 | 0.012 | 0 | 0.01 |
| Enzyme 7 | 0.006 | 0.01 | 0.03 | 0 | 0 | 0.01 |
| borax | 1.1 | 1.7 | 3 | 0.1 | 0 | 0 |
| Tropolone | 1.25 | 1.5 | 1.75 | 2.0 | 2.25 | 2.50 |
| Misc (water, | Balance | Balance | Balance | Balance | Balance | Balance |
| brightener, | | | | | | |
| solvent, cleaning | | | | | | |
| polymer, etc.) | | | | | | |

¹C12-15EO2.5S AlkylethoxySulfate where the alkyl portion of AES has a molecular weight of 211 to 218 daltons, available from P&G Chemicals;
²branched alkyl sulfate Example Z;
³High C12 (96%)Linear Alkyl Benzene Sulfonate sourced from P&G Chemicals;
⁴Surfonic L24-9 commercially available from Huntsman;
⁵C12/C14 Amine Oxide sourced from P&G Chemicals;
⁶Citrosol 502 commercially available from Archer Daniels Midland;
⁷ Preferenz commercially available from DuPont;
⁸ Arctic commercially available from Novozymes;
⁹ Disodium tetraborate pentahydrate commercially sourced from Univar Solutions;
¹⁰ PE-20 commercially available from BASF;
¹¹Sodium lauryl sulfate available from P&G Chemicals

The composition examples can be prepared by combining all raw materials to achieve Composition A, with exception of not adding all of the water to leave space (referred to as a hole) to add in the branched alkyl sulfate and alkyl ethoxy sulfate for Compositions B-G and Compositions 1-3. To make Composition A, the following raw materials can be mixed rapidly to achieve a vortex with a mixing impeller for about 60 minutes: some water, solvent, surfactant (any surfactant not the branched alkyl sulfate or the alkyl ethoxy sulfate), borax, stabilizer, neutralizer, builder, chelant, polymer, and enzyme to result in a stable one phase liquid.

To make Compositions B-G and Compositions 1-3, the branched alkyl sulfate and alkyl ethoxy sulfate can be added on top of Composition A (with the hole) to achieve the desired levels. Before remaining water is added to balance the formulas, caustic or sulfuric is added to achieve a consistent pH of 8.2-8.6.

Compositions 4-9 can be made by rapidly mixing the following materials to achieve a vortex with a mixing impeller for about 60 minutes: some water, solvent, surfactant, borax, stabilizer, neutralizer, builder, chelant, polymer, and enzyme to result in a stable one phase liquid. Before remaining water is added to balance the formulas, caustic or sulfuric is added to achieve a consistent pH of 8.2-8.6.

### Further Definitions and Cross-References

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications may be made without departing from the spirit and scope of the invention. It is therefore intended to cover in the appended claims all such changes and modifications that are within the scope of this invention.

What is claimed is:

1. A liquid detergent composition comprising:
at least one component, according to one or more of Formulas 7-12: 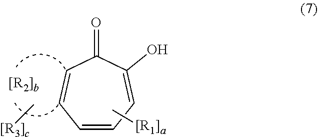
wherein:
R₁ is hydroxyl, C₁-C₆ carboxyl, a linear or branched C₁-C₆ alkyl; a linear or branched C₂-C₆ alkenyl; or a linear or branched C₂-C₆ alkynyl group;
a is from 0 to 5;
R₂ is a fused C₁-C₆ cycloalkyl, a fused C₁-C₆ cycloalkoxy, or a fused C₁-C₆ cycloalkenyl;
b is from 0 to 4;
R₃ is oxygen or hydroxyl; and
c is from 0 to 4,
and combinations and salts thereof;

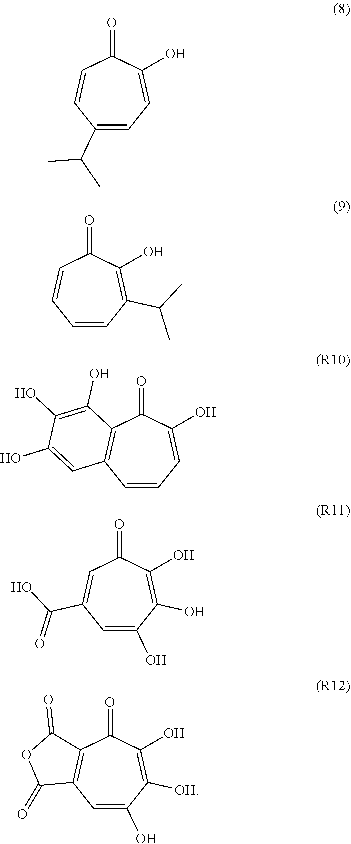

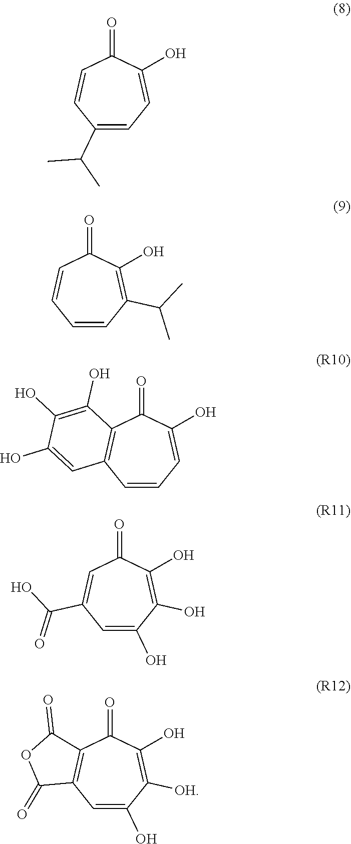

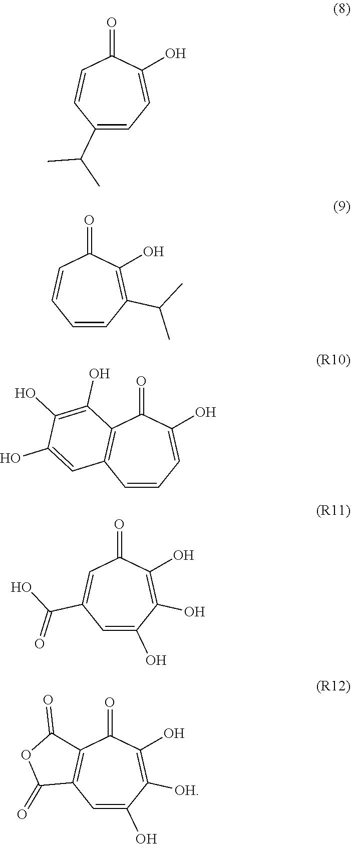

2. The liquid detergent composition according to claim 1, wherein the at least one component according to Formula 7 is tropolone.

3. The liquid detergent composition according to claim 1, wherein the at least one component according to Formula 7 is hinokitiol.

4. The liquid detergent composition according to claim 1, wherein the at least one component has a pKa of less than about 8.

5. The liquid detergent composition according to claim 1, wherein the at least one component has a calcium binding efficiency of less than about 7.

6. The liquid detergent composition according to claim 1, wherein the at least one component has an iron binding efficiency greater than about 10.

7. The liquid detergent composition according to claim 1, wherein the at least one component is present in an amount of from greater than about 0 to about 10% by weight of the liquid detergent composition.

8. The liquid detergent composition according to claim 1, further comprising a surfactant comprising an anionic surfactant, a nonionic surfactant, or a combination thereof.

9. The liquid detergent composition according to claim 8, wherein the surfactant is an anionic surfactant comprising at least one of sodium lauryl sulfate, linear alkyl benzene sulfonic acid, branched 2-alkyl primary alkyl alcohol sulfate, alkyl sulphate, or a combination thereof.

10. A single unit dose detergent comprising the liquid detergent composition according to claim 1.

11. A method for treating a stain on a fabric, comprising:
washing the fabric in a wash liquor comprising a liquid detergent composition comprising at least one component, according to any of Formulas 7-12: 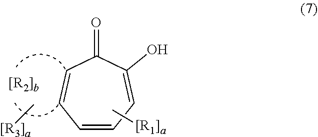
wherein:
R₁ is hydroxyl, C₁-C₆ carboxyl, a linear or branched C₁-C₆ alkyl; a linear or branched C₂-C₆ alkenyl; or a linear or branched C₂-C₆ alkynyl group;
a is from 0 to 5;
R₂ is a fused C₁-C₆ cycloalkyl, a fused C₁-C₆ cycloalkoxy, or a fused C₁-C₆ cycloalkenyl;
b is from 0 to 4;
R₃ is oxygen or hydroxyl; and
c is from 0 to 4,
and combinations and salts thereof;

12. The method according to claim 11, wherein the at least one component according to Formula 7 is tropolone.

13. The method according to claim 11, wherein the at least one component according to Formula 7 is hinokitiol.

14. The method according to claim 11, wherein the at least one component has a pKa of less than about 8.

15. The method according to claim 11, wherein the at least one component has a calcium binding efficiency of less than about 7.

16. The method according to claim 11, wherein the at least one component has an iron binding efficiency greater than about 10.

17. The method according to claim 11, wherein the at least one component is present in an amount of from greater than about 0 to about 10% by weight of the liquid detergent composition.

18. The method according to claim 11, further comprising maintaining the pH of the wash liquor at less than about 10.

19. The method according to claim 11, wherein the liquid detergent composition is delivered to the wash liquor via a single unit dose detergent comprising the liquid detergent composition.

20. A method for pre-treating a stain on a fabric, comprising:
applying a liquid detergent composition to the fabric, the liquid detergent composition comprising at least one component, according to one or more of Formulas 7-12: 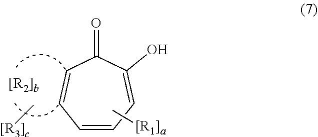
wherein:
R₁ is hydroxyl, C₁-C₆ carboxyl, a linear or branched C₁-C₆ alkyl; a linear or branched C₂-C₆ alkenyl; or a linear or branched C₂-C₆ alkynyl group;
a is from 0 to 5;
R₂ is a fused C₁-C₆ cycloalkyl, a fused C₁-C₆ cycloalkoxy, or a fused C₁-C₆ cycloalkenyl;
b is from 0 to 4;
R₃ is oxygen or hydroxyl; and
c is from 0 to 4,
and combinations and salts thereof;
